(19) United States
(12) Patent Application Publication
(10) Pub. No.: US 2003/0026919 A1
(43) Pub. Date: Feb. 6, 2003

(54) Optical fiber resin coating apparatus and optical fiber resin coating method

(76) Inventors: Hidekazu Kojima, Kanagawa (JP); Toshio Shibata, Chiba (JP); Shinji Harada, Chiba (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/195,843

(22) Filed: Jul. 11, 2002

(30) Foreign Application Priority Data
Jul. 11, 2001 (JP) 2001-211111
Jul. 17, 2001 (JP) 2001-217072
Jul. 17, 2001 (JP) 2001-217087
Sep. 14, 2001 (JP) 2001-280338

(51) Int. Cl. B05D 3/06

(52) U.S. Cl. 427/558; 118/620; 118/663

(57) ABSTRACT

An optical fiber resin coating apparatus having an ultraviolet flash lamp used for coating an optical fiber by an ultraviolet curing resin, a lamp lighting circuit for making the ultraviolet flash lamp emit light, and a control circuit for controlling this lamp lighting circuit. The control circuit detects the intensity and emission time of ultraviolet light emitted from the ultraviolet flash lamp by an ultraviolet sensor and supplies a voltage and excitation time to the power source for exciting the ultraviolet flash lamp based on this. As the ultraviolet light source, at least one ultraviolet laser diode or ultraviolet light emitting diode may be used instead of an ultraviolet flash lamp. The ultraviolet light source may be arranged to emit ultraviolet light so that the coating portion of the ultraviolet curing resin exhibits an inclined profile where the intensity of the ultraviolet light gradually changes according to the position.

### BACKGROUND OF THE INVENTION

1. Field of the Invention

The present invention relates to an optical fiber resin coating apparatus and method used for producing a resin coating for protecting an optical fiber or optical component.

More specifically, the present invention relates to an apparatus and method for curing a resin coating of an optical fiber by ultraviolet light (optical fiber resin curing apparatus and method).

2. Description of the Related Art

Optical fibers and optical components are protected by coating the surfaces of the optical fibers with a resin. That is, when producing an optical fiber, the periphery of the naked optical fiber drawn from a preform is coated with an ultraviolet curing resin and an optical fiber resin coating apparatus is used to irradiate the resin by ultraviolet light to cure the ultraviolet curing resin.

Further, at the connection and/or processed parts etc. of optical fibers and optical components, the coating is stripped for the connection and/or processing. After the optical fibers are connected and/or processed, then the peripheries of the connected parts and/or the peripheries of the processed parts are protected by coating them with an ultraviolet curing resin and curing the coated resin using an optical fiber resin curing apparatus to recoat and thereby reinforce the fibers.

### SUMMARY OF THE INVENTION

An object of the present invention is to provide a small-sized optical fiber resin coating apparatus.

Another object of the present invention is to provide an optical fiber resin coating apparatus and method featuring a small power consumption.

Still another object of the present invention is to provide an optical fiber resin coating apparatus and method which enables the work time to be shortened.

Still another object of the present invention is to provide an optical fiber resin coating apparatus and method which enables an ultraviolet resin to be cured while not leaving bubbles in the resin.

According to a first aspect of the present invention, there is provided an optical fiber resin coating apparatus having an ultraviolet flash lamp for emitting ultraviolet light for curing an ultraviolet curing resin coated on an optical fiber, a lamp lighting means for lighting the ultraviolet flash lamp, and a control means for controlling the lamp lighting circuit to light the ultraviolet flash lamp for a short time.

According to a second aspect of the present invention, there is provided an optical fiber resin coating apparatus having an ultraviolet flash lamp for emitting ultraviolet light for curing an ultraviolet curing resin coated on an optical fiber, a lamp lighting means for lighting the ultraviolet flash lamp, an ultraviolet light measuring means for measuring an intensity and emission time of ultraviolet light emitted from the ultraviolet flash lamp, and an ultraviolet flash lamp excitation control means for calculating a voltage for exciting the ultraviolet flash lamp and excitation time by referring to the intensity and emission time of ultraviolet light measured by the ultraviolet light measuring means and supplying the same to the power source means, the lamp lighting means lights the ultraviolet flash lamp in response to the excitation voltage and excitation time supplied from the control means.

According to a third aspect of the present invention, there is provided an optical fiber resin coating method having the steps of coating an ultraviolet curing resin as an outer coating of an optical fiber, curing the coated ultraviolet curing resin by supplying voltage to an ultraviolet flash lamp to cause the ultraviolet flash lamp to emit ultraviolet light, measuring an intensity and emission time of the ultraviolet light, and calculating a voltage for exciting the ultraviolet flash lamp and excitation time by referring to the measured intensity and emission time of ultraviolet light and supplying the voltage to the ultraviolet flash lamp, in the voltage supplying step, the ultraviolet flash lamp being lit in response to the excitation voltage supplied at the control step and excitation time.

According to a fourth aspect of the present invention, there is provided an optical fiber resin coating apparatus which coats a periphery of an optical fiber with an ultraviolet curing resin and irradiates the ultraviolet curing resin with ultraviolet light to cure the ultraviolet curing resin, wherein at least one ultraviolet laser diode or ultraviolet light emitting diode is used for a light source of the ultraviolet light.

According to a fifth aspect of the present invention, there is provided an optical fiber resin coating apparatus which coats a periphery of an optical fiber with an ultraviolet curing resin and irradiates the ultraviolet curing resin with ultraviolet light to cure the ultraviolet curing resin, the optical fiber drawn from a preform, at least one ultraviolet laser diode or ultraviolet light emitting diode used for an ultraviolet light source.

According to a sixth aspect of the present invention, there is provided an optical fiber resin coating apparatus which fills an ultraviolet curing resin at a periphery of a coating formation portion of an optical fiber set in a groove of a mold assembly in a housing, irradiates the ultraviolet curing resin with ultraviolet light to cure the ultraviolet curing resin, and thereby coats the coating formation portion of the optical fiber, wherein at least one ultraviolet laser diode or ultraviolet light emitting diode is used for an ultraviolet light source.

According to a seventh aspect of the present invention, there is provided an optical fiber resin coating apparatus provided with an ultraviolet light source for irradiating an uncured ultraviolet curing resin covering a coating formation portion of an optical fiber by ultraviolet light of an inclined profile where the intensity of the ultraviolet light gradually changes depending on the position.

According to an eighth aspect of the present invention, there is provided an optical fiber resin coating method comprising covering and coating a coating formation portion of an optical fiber by an ultraviolet curing resin by irradiating an uncured ultraviolet curing resin covering the coating formation portion of the optical fiber with ultraviolet light exhibiting an inclined profile where the intensity of the ultraviolet light gradually changes depending on the position and performing the curing processing to successively move from one uncured position to another.

### BRIEF DESCRIPTION OF THE DRAWINGS

These and other objects and features of the present invention will become clearer from the following description of the preferred embodiments given with reference to the attached drawings, wherein:

FIG. 1 is a perspective view of the appearance of an optical fiber resin coating apparatus of a first embodiment of the present invention;

FIG. 2 is a perspective view illustrating components of the optical fiber resin coating apparatus illustrated in FIG. 1;

FIG. 3 is a view illustrating a control system of the optical fiber resin coating apparatus illustrated in FIG. 2;

FIG. 4 to FIG. 6 are views of lamp lighting circuits in the optical fiber resin coating apparatus illustrated in FIG. 2;

FIG. 7 is a block diagram of a control circuit in the optical fiber resin coating apparatus illustrated in FIG. 2;

FIGS. 8A to 8D are views of a first data holding means and its operation in the optical fiber resin coating apparatus illustrated in FIG. 2;

FIGS. 9A to 9E are views of a second data holding means and its operation in the optical fiber resin coating apparatus illustrated in FIG. 2;

FIG. 10 is a flow chart of a first control operation of the first embodiment of the present invention;

FIG. 11 is a flow chart of a second control operation of the first embodiment of the present invention;

FIG. 12 is a perspective view illustrating components of an optical fiber resin coating apparatus of a second embodiment of the present invention;

FIGS. 13A to 13E are views showing the operation of the optical fiber resin coating apparatus of FIG. 12;

FIG. 14 is a view of the control system of the optical fiber resin coating apparatus shown in FIG. 12;

FIG. 15 and FIG. 16 are circuit diagrams of lamp lighting circuits used in the optical fiber resin coating apparatus shown in FIG. 12;

FIG. 17 is a perspective view illustrating components of an optical fiber resin coating apparatus according to a first modification of the second embodiment of the present invention;

FIGS. 18A to 18E are views showing an operation of the optical fiber resin coating apparatus of FIG. 17;

FIG. 19 is a perspective view illustrating components of an optical fiber resin coating apparatus of a second modification of the second embodiment of the present invention;

FIGS. 20A to 20C are views showing an operation of the optical fiber resin coating apparatus of FIG. 19;

FIG. 21 is a view of a control system of the optical fiber resin coating apparatus shown in FIG. 19;

FIG. 22 is a perspective view illustrating components of an optical fiber resin coating apparatus of a third modification of the second embodiment of the present invention;

FIGS. 23A to 23C are views showing an operation of the optical fiber resin coating apparatus of FIG. 22;

FIGS. 24A to 24E are views showing an operation of an optical fiber resin coating apparatus of a fourth modification of the second embodiment of the present invention;

FIGS. 25A to 25C are views showing an operation of an optical fiber resin coating apparatus of a fifth modification of the second embodiment of the present invention;

FIGS. 26A and 26B are views showing an operation of an optical fiber resin coating apparatus of a sixth modification of the second embodiment of the present invention;

FIGS. 27A to 27C are views showing an operation of an optical fiber resin coating apparatus of a seventh modification of the second embodiment of the present invention;

FIG. 28 is a perspective view illustrating components of an optical fiber resin coating apparatus of a third embodiment of the present invention;

FIG. 29 is a view of a control system of the optical fiber resin coating apparatus shown in FIG. 28;

FIGS. 30A to 30D are views of an operation of the optical fiber resin coating apparatus shown in FIG. 28;

FIG. 31 is a view of a control system of an optical fiber resin coating apparatus of a first modification of the third embodiment of the present invention;

FIG. 32 is a perspective view of an optical fiber resin coating apparatus of a fourth embodiment of the present invention; and

FIG. 33 is a view of a control system of the optical fiber resin coating apparatus illustrated in FIG. 32.

### DESCRIPTION OF THE PREFERRED EMBODIMENTS

Optical fiber resin coating apparatuses and optical fiber resin coating methods of preferred embodiments of the present invention will be described in detail below while referring to the attached figures.

First Embodiment

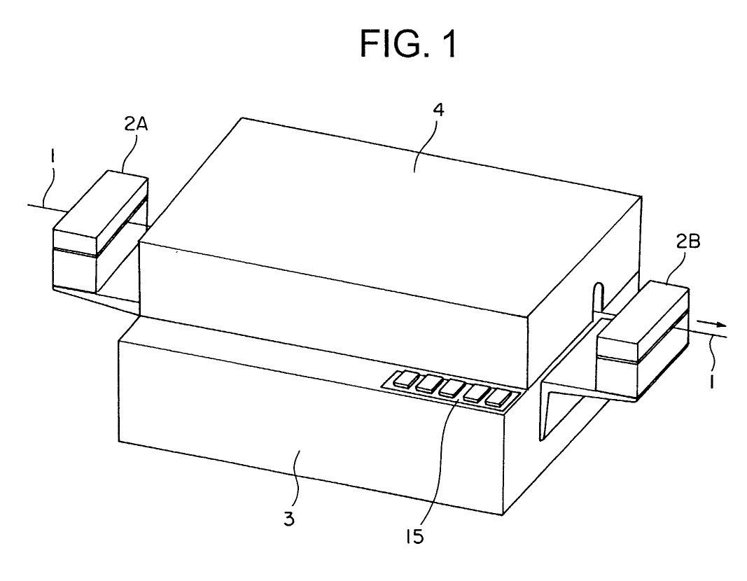

An optical fiber resin coating apparatus according to a first embodiment of the present invention will be described with reference to FIG. 1 to FIG. 11.

Configuration of Optical Fiber Resin Coating Apparatus

The configuration of the optical fiber resin coating apparatus of the first embodiment of the present invention will be explained first with reference to FIG. 1 to FIG. 3.

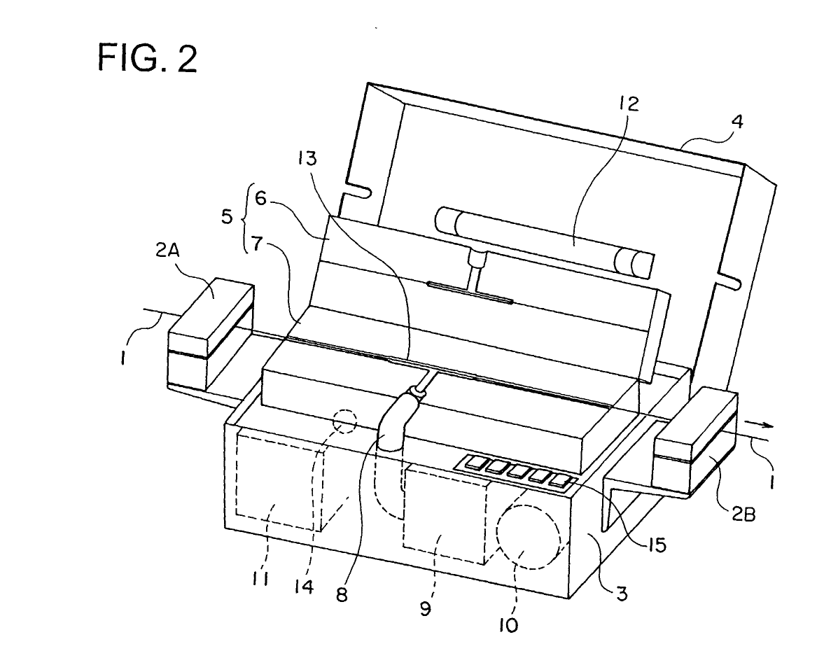

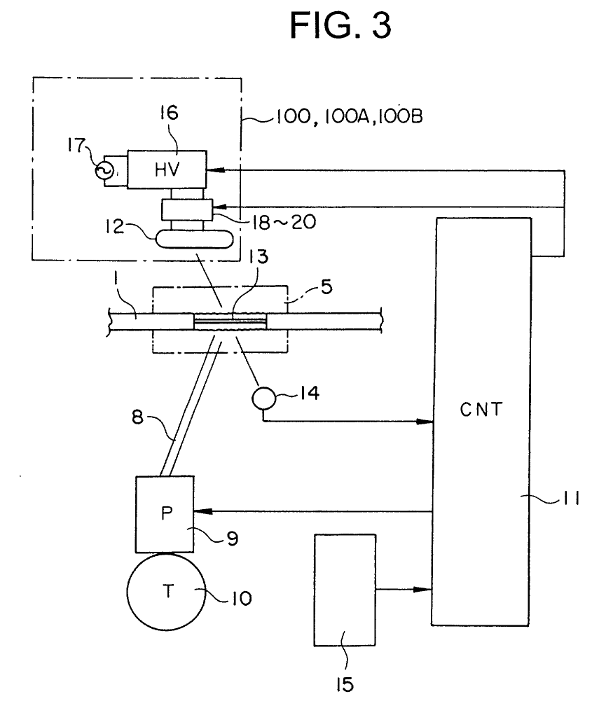

FIG. 1 is a perspective view of the appearance of the optical fiber resin coating apparatus of the first embodiment of the present invention, FIG. 2 is a perspective view of the inside of the optical fiber resin coating apparatus illustrated in FIG. 1, and FIG. 3 is a view of a control system.

The optical fiber resin coating apparatus of the first embodiment, as shown in FIG. 2, is provided with clamps 2A and 2B for clamping an optical fiber 1 for coating by a resin, a mold assembly 5 for molding an ultraviolet coating formation portion 13 of the optical fiber 1 to a desired shape, a pipe 8 for feeding an ultraviolet curing resin into the mold assembly 5, a pump 9 for pumping the ultraviolet curing resin from a tank 10 and supplying it through the pipe 8 to the mold assembly 5, an ultraviolet light source 12, an ultraviolet sensor 14 for measuring the amount of light of the ultraviolet light source 12, a control circuit 11 for controlling the optical fiber resin coating apparatus, and a control panel 15.

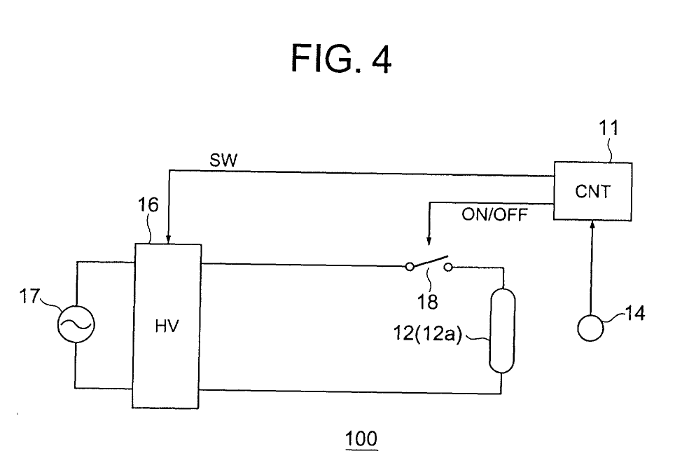

The optical fiber resin coating apparatus further has a lamp lighting circuit of the ultraviolet light source 12 explained in detail referring to FIG. 4 to FIG. 6. The lamp lighting circuit is illustrated in FIG. 3 as a primary power source 17, a high voltage power source 16, and other circuits 18 to 20.

The mold assembly 5 is divided into an upper mold 6 and lower mold 7 for holding the optical fiber 1 in the optical fiber resin coating apparatus.

The optical fiber resin coating apparatus has a lower housing 3 for holding the above components and an upper lid 4. When the upper lid 4 is closed, as illustrated in FIG. 1, the lower housing 3 and the upper lid 4 form a dark box except at the portions through which the optical fiber 1 passes.

As illustrated in FIG. 3, the ultraviolet curing resin is injected into the mold assembly 5 in which the coating formation portion 13 of the optical fiber 1 is arranged by the operator depressing a switch of the control panel 15 to instruct this to the control circuit 11. The control circuit 11 receiving the instruction from the operator operates the pump 9 to send a suitable amount of the ultraviolet curing resin from the tank 10 to the pipe 8. Further, the control circuit 11 controls the high voltage power source 16 and switches of the drive circuit of the ultraviolet light source 12 to control the drive power of the ultraviolet light source 12.

The ultraviolet light emitted from the ultraviolet light source 12 irradiates the coating formation portion 13 to cure the resin.

The control circuit 11 is comprised for example using a computer. A control program built into the computer performs the various types of processing explained below.

Ultraviolet Flash Lamp

The present inventors took note of the fact that the curing time could be shortened if the total amount of light could be secured and, hence came up with the idea of irradiating the resin with strong ultraviolet light in a short time. As the ultraviolet light source 12 capable of meeting this condition, they decided to use a small-sized ultraviolet flash lamp.

An ultraviolet flash lamp emits a large amount of high luminance light of the ultraviolet band in a short time. For example, it is possible to obtain a flash of a large amount of high luminance light having a spectrum strong in the ultraviolet band by an ultraviolet flash lamp containing xenon gas. As a xenon ultraviolet flash lamp, for example, it is possible to use a xenon ultraviolet flash lamp made by Ushio Electric.

In the optical fiber resin coating apparatus of the first embodiment, the recoating portion is small and the total amount of light required for each curing is small. Therefore, the optical fiber resin coating apparatus of the first embodiment of the present invention is small in dimensions.

Comparative Example

A lamp lighting system including the high voltage power source in the optical fiber resin coating apparatus of the first embodiment of the present invention exhibits the following numerical values compared with a lamp lighting system including a high voltage power source of an optical fiber resin coating apparatus of the prior art not using the ultraviolet flash lamp 12.

The optical fiber resin coating apparatus of the comparative example emits ultraviolet light to an optical fiber from, for example, a tungsten lamp, a mercury discharge arc lamp, a microwave electroless lamp, or other ordinary continuously lit ultraviolet lamp in a state with the core of the optical fiber 1 and the ultraviolet curing resin placed in the mold assembly 5 designed for the recoating diameter when recoating a stripped portion of the optical fiber 1. These ultraviolet lamps, however, only use a small part of the wavelength emitted by the lamps. For example, a tungsten lamp emits a large amount of light in the infrared band longer than the visible light band, so the efficiency of emission of ultraviolet light is low. Therefore, the power source for supplying the power also becomes larger in size.

TABLE 1

| | Outside | Weight | Volume | Weight |
|---|---|---|---|---|
| | dimensions | (g) | ratio | ratio |
| Comparative | 76 × 243 × | 2000 | 1 | 1 |
| example | 129 (mm³) | | | |
| Example of | 83 × 260 × | 500 | 1/2 | 1/4 |
| invention | 64 (mm³) | | | |

Lamp Lighting Circuit

Lamp lighting circuits used for the optical fiber resin coating apparatus of the first embodiment of the present invention will be explained next referring to FIG. 4 to FIG. 6. The optical fiber resin coating apparatus of the first embodiment of the present invention may use any of the lamp lighting circuits illustrated in FIG. 4 to FIG. 6.

FIG. 4 is a view of the circuit configuration of a first example of the lamp lighting circuit.

A lamp lighting circuit 100 has a primary power source 17, a high voltage power source 16, and a switch 18.

The high voltage power source 16 for example has a rectifier circuit for rectifying the AC voltage from the primary power source 17 to a direct current and a switching regulator switching at a frequency in accordance with a switching operation command SW from the control circuit 11 and boosting the rectified DC voltage to a high voltage required for lighting the ultraviolet flash lamp 12. As the primary power source 17, it is possible to use the AC commercial power source.

The DC voltage boosted at the high voltage power source 16 is supplied to the ultraviolet flash lamp 12 through the switch 18 turning ON or OFF in accordance with an ON-OFF drive command of the control circuit 11. The ultraviolet flash lamp 12 outputs ultraviolet light of an intensity in accordance with the power supplied.

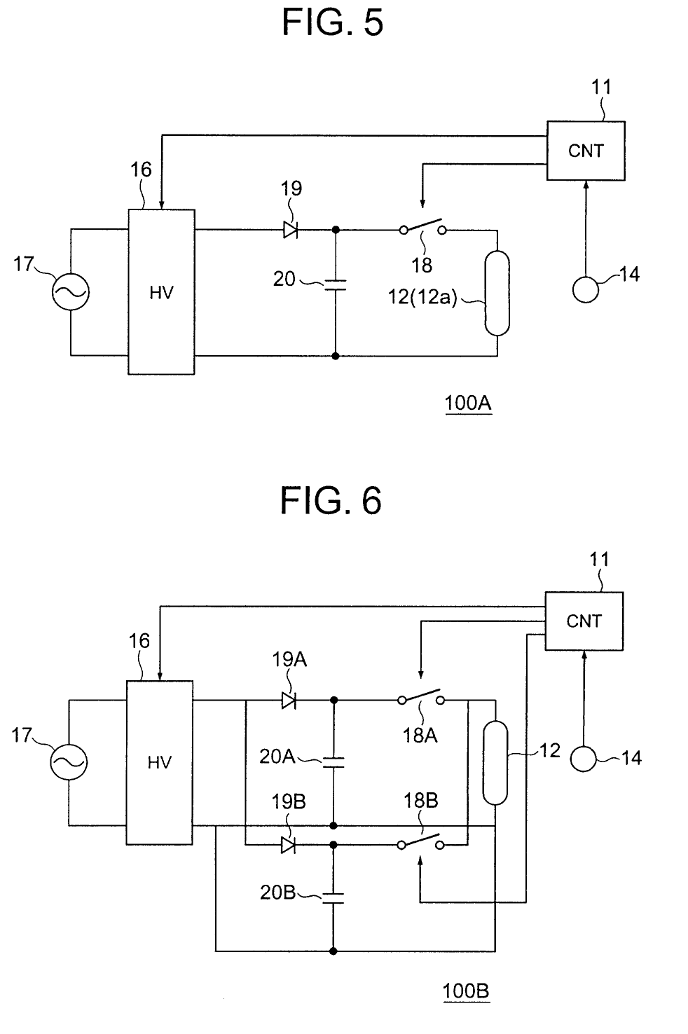

FIG. 5 is a view of the circuit configuration of a second example of a lamp lighting circuit.

A lamp lighting circuit 100A illustrated in FIG. 5 has a primary power source 17, a high voltage power source 16, a diode 19 for preventing reverse current, a switch 18, and a capacitor 20 for storing high voltage power. The primary power source 17, the high voltage power source 16, and the switch 18 of the lamp lighting circuit 100 are similar to those described with reference to FIG. 4.

The lamp lighting circuit 100A is composed of the high voltage power source 16 for generating the high voltage required for lighting the ultraviolet flash lamp 12, the diode 19, the capacitor 20, and the switch 18 for controlling the flash operation of the ultraviolet flash lamp 12 to enable the ultraviolet curing resin to be cured in a short time.

Note that the capacitor 20 has the function of smoothing the ripples included in the DC power obtained by rectification by the diode 19 to obtain good quality direct current with little ripple and supplying the same to the ultraviolet flash lamp 12.

The control circuit 11 compares a command signal for exciting the ultraviolet flash lamp 12 and an output of an ultraviolet sensor 14 receiving the light of the ultraviolet flash lamp 12 and converting it to a corresponding electrical signal. The control circuit 11 sends a light adjusting signal to the high voltage power source 16 in accordance with control error found by the comparison. The control circuit 11 further controls the turning ON/OFF of the switch 18 ON-OFF.

The control circuit 11 usually sets the switch 18 in the OFF state and stores the power from the high voltage power source 16 in the capacitor 20. The control circuit 11 turns the switch 18 ON to flash the ultraviolet flash lamp 12 only when recoating the optical fiber.

According to the optical fiber resin coating apparatus using the lamp lighting circuit illustrated in FIG. 5, even if not using a large capacity high voltage power source 16, it is possible to light the ultraviolet flash lamp 12 by the power stored in the capacitor 20 by exactly the amount of light for curing the ultraviolet curing resin in a short time. Therefore, the optical fiber resin coating apparatus of the first embodiment of the present invention consumes only a small amount of power.

FIG. 6 is a view of the circuit configuration of a third example of the lamp lighting circuit.

A lamp lighting circuit 100B illustrated in FIG. 6 is comprised of a primary power source 17, a high voltage power source 16 for generating the high voltage required for lighting the ultraviolet flash lamp 12 by the primary power source 17, a first diode 19A for preventing reverse current, a first capacitor 20A for storing high voltage power, a first switch 18A for controlling the flashing of the ultraviolet flash lamp 12, a second diode 19B for preventing reverse current, a second capacitor 20B for storing high voltage power, and a second switch 18B for controlling the flashing of the ultraviolet flash lamp 12.

The lamp lighting circuit 100B is provided in parallel with a first circuit comprised of the first diode 19A, the first capacitor 20A, and the first switch 18A, and a second circuit comprised of the second diode 19B, the second capacitor 20B, and the second switch 18B.

The power from the high voltage power source 16 is stored in the capacitors 20A and 20B through the diodes 19A and 19B. Reverse current is prevented by these diodes 19A and 19B. By closing the switches 18A and 18B by the control circuit 11 for controlling the flashing of the ultraviolet flash lamp 12, the charges stored in the capacitors 20A and 20B are supplied to the ultraviolet flash lamp 12. While the switches 18A and 18B are opened, the power from the high voltage power source 16 is stored in the capacitors 20A and 20B. Hence, the high voltage power source 16 is sufficient in terms of capacity even if small in size. The switches 18A and 18B are controlled by the control circuit 11 to alternately open and close. Due to this, a the leeway at least twice of the lamp lighting circuit of the circuit configuration of FIG. 4 is possible in the charging and discharging of the capacitors 20A and 20B. Therefore, when envisioning the same output as the configuration of FIG. 5, there is the advantage that the flashing interval can be shortened to half.

As the lamp lighting circuit, it is possible to provide in parallel at least three circuits each comprised of the diode 19, the capacitor 20, and the switch 18 to further shorten the flashing interval of the ultraviolet flash lamp 12.

Control Circuit

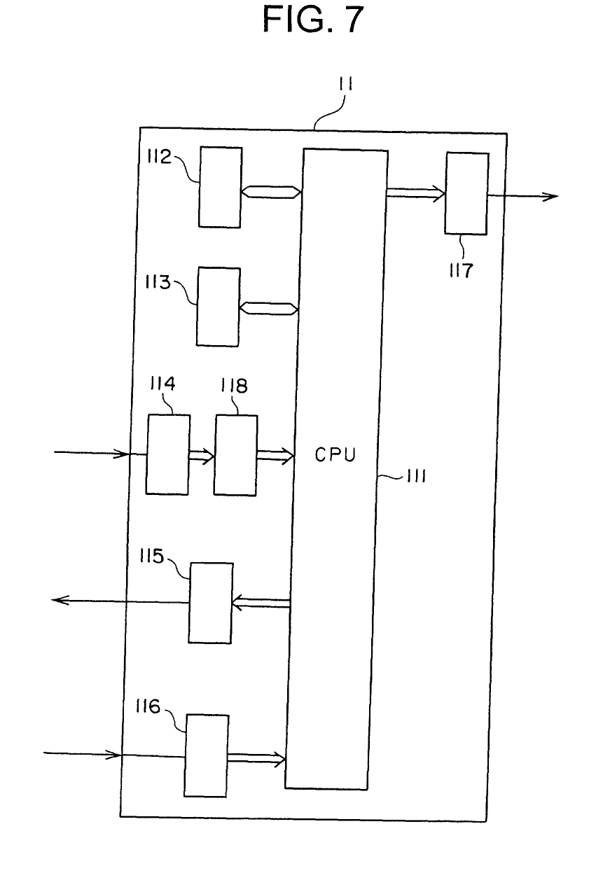

FIG. 7 is a block diagram of one example of the configuration of the control circuit 11.

The control circuit 11 is comprised using a computer and has a central processing unit (CPU) 111 as a processing means of the computer, a random access memory (RAM) 112, a read only memory (ROM) 113, an analog-to-digital (A/D) converter 114, a data holder 118, and data ports 115, 116, and 117.

The computer program for control built into the RAM 112 and/or ROM 113 executes the following various types of processing in the CPU 111.

The basic control processing of the optical fiber resin coating apparatus will be explained next.

An ultraviolet curing resin is injected into the mold assembly 5 by the operator depressing a switch of the control panel 15 to instruct this to the CPU 111 through the data port 116. The CPU 111 receiving the instruction operates the pump 9 through the data port 115 to send a suitable amount of the ultraviolet curing resin from the tank 10 to the pipe 8.

When curing the ultraviolet curing resin, the CPU 111 outputs an ON-OFF command signal to the switch 18, 18A, or 18B of one of the lamp lighting circuits 100, 100A, and 100B through the data port 117 in accordance with the value of a data table written in advance in the ROM 113 to light the ultraviolet flash lamp 12 powered by the high voltage power source 16. In this way, the ultraviolet flash lamp 12 is controlled by the program of the control circuit 11.

The CPU 111 receives as input through the A/D converter 114 the output of the ultraviolet sensor 14 receiving the ultraviolet light from the excited ultraviolet flash lamp 12 and converting it to an electrical signal corresponding to its intensity and emission time, holds this in the data holder 118, and compares it with a target value, that is, a value of the data table. The CPU 111 instructs the adjustment of the amount of light to the high voltage power source 16 to adjust the boost voltage in the high voltage power source 16 in accordance with the control error obtained by the comparison.

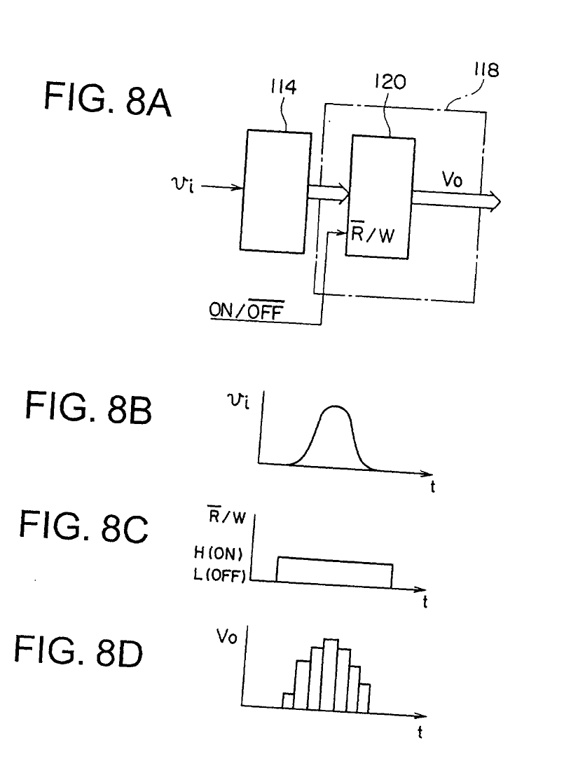

FIG. 8A is a view of the configuration of a first example of the data holding means.

The data holder 118 serving as the data holding means uses a data memory 120 as a data storage device.

The analog data vi from the ultraviolet sensor 14 shown in FIG. 8B is converted to digital data by a predetermined sampling rate by the A/D converter 114. The converted digital data during the interval when the signal shown in FIG. 8C expressing the emission time of the ultraviolet flash lamp 12 is input is fetched and stored in the data memory 120. Due to this, the digital data V0 for control shown in FIG. 8D is obtained.

In the data holding means, the sum of the sampled digital data corresponds to the total amount of light of the ultraviolet flash lamp 12 during the emission period.

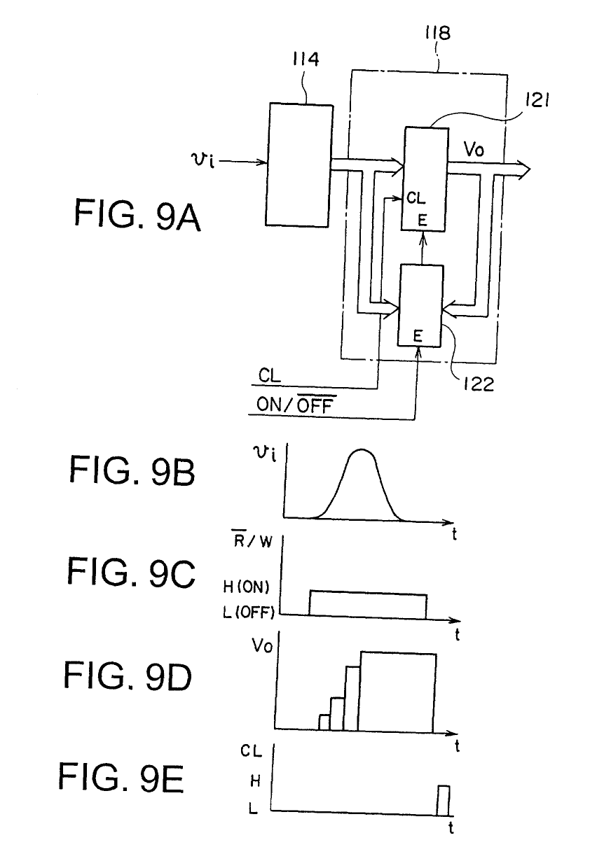

FIG. 9A is a view of another configuration of the data holding means.

In the data holding means of this configuration, a latch 121 is used as the storing device of the data of the data holder 118 and a comparator 122 is used.

The portions other than the data holding means are the same in all cases.

The analog data vi from the ultraviolet sensor 14 shown in FIG. 9B is converted to digital data of the predetermined sampling rate by the A/D converter 114. The converted digital data in the interval while the signal shown in FIG. 9C expressing the emission time of the ultraviolet flash lamp 12 is being input among all of the data is fetched. At this time, the maximum value of the data is judged by the comparator 122 and the maximum value is latched by the latch 121. This being so, the control digital data V0 shown in FIG. 9D is obtained. When the data is refetched, the data clear signal shown in FIG. 9E is transmitted to release the latch 121.

The total amount of light is called up from the data table of the total amount of light/maximum value measured in advance and written in the ROM 113 for use for control.

First Control Method

If the emission time of the ultraviolet flash lamp is short, it may become difficult to adjust the intensity or emission time of the ultraviolet light. The ultraviolet curing resin may be insufficiently cured or is overly cured, and the quality of the coating may vary.

Therefore, when using the ultraviolet flash lamp to coat the optical fiber, the inventors optimally cure the ultraviolet curing resin without excess or shortage by adjusting the ultraviolet light from the ultraviolet flash lamp to a high accuracy.

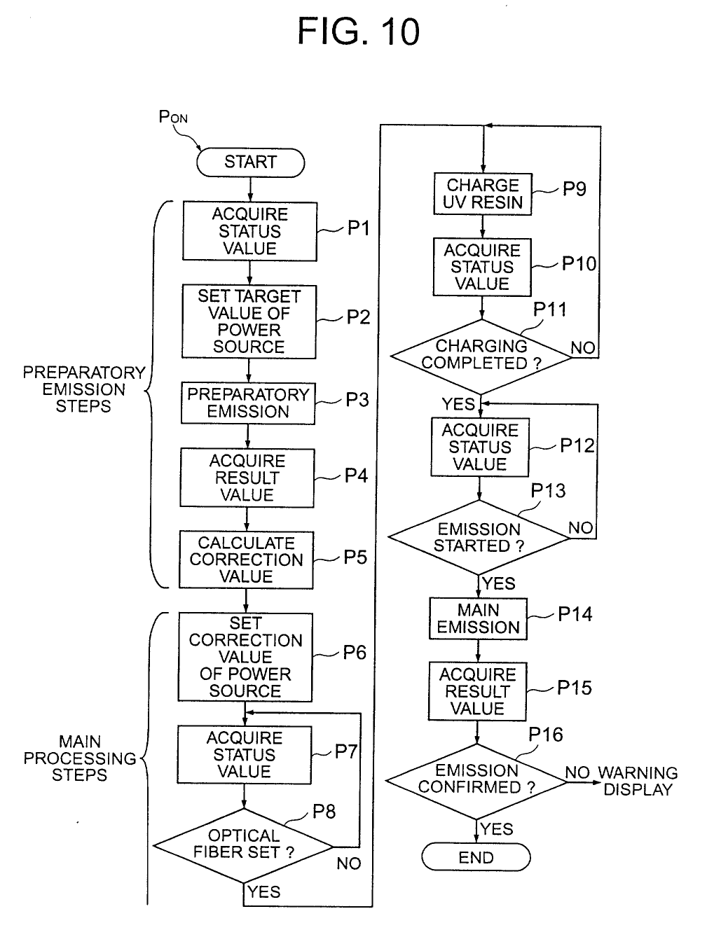

FIG. 10 is a flow chart of a first example of the operation of an optical fiber resin coating apparatus of a first embodiment of the present invention.

Preparatory Emission Steps: P1 to P5

P1: When the optical fiber resin coating apparatus starts operating, at step 1 (P1), the amount of emission, emission time, and other target values of the ultraviolet flash lamp input by the operator from the control panel 15 and the information and other various states from the input/output means (I/O) of the various parts of the coating apparatus are input to the control circuit 11.

P2: The target values of the high voltage power source 16 (excitation voltage and excitation time) are set from the control circuit 11 based on the input information of step P1.

P3: The control information of the excitation voltage and excitation time set at step P2 is sent from the control circuit 11 to the high voltage power source 16 and/or switch 18. The high voltage power source 16 and/or switch 18 light up the ultraviolet flash lamp 12 based on this information for the preparatory emission of the ultraviolet flash lamp 12.

P4: The output light of the ultraviolet flash lamp 12 is measured by the ultraviolet sensor 14. The value of the emission result at step P3 which had been held as the sampled digital data V0 is fetched from the data holder 118 of the data holding means.

P5: The control circuit 11 compares the value of the emission result of step P4 and calculates the target value and the correction value.

Main Processing Steps: P6 to P16

P6: The correction value for the high voltage power source 16 is set by the control circuit 11 based on the correction value at step P5.

P7: A status value relating to the state of the optical fiber 1 on which the resin is to be coated and cured set in the mold assembly 5 is obtained from the control panel 15 and the I/Os of the various parts.

P8: The set state of the optical fiber 1 is judged based on the status value of step P7. If the setting of the optical fiber 1 is not completed, the routine returns to the process of step P7 and the set state is confirmed again. If judged that the set is completed, the routine proceeds to the processing of step P9.

P9: A command from the control circuit 11 is received and the pump 9 charges the mold assembly 5 with the ultraviolet curing resin from the tank 10 through the pipe 8.

P10: The status value relating to the state of charging the ultraviolet curing resin in the mold assembly 5 is obtained from the control panel 15 and the I/Os of the different parts.

P11: The charged state of the ultraviolet curing resin is judged based on the status value at step P10. If charging of the ultraviolet curing resin is not completed, the routine returns to the processing of step P9 and the resin is recharged one more time. If it is judged that charging of the resin has completed, the routine proceeds to the processing of step P12.

P12: As a preparatory step of emission of the ultraviolet flash lamp 12, the various types of status values of the control panel 15 and the I/Os of the different parts are obtained.

P13: It is judged if the ultraviolet flash lamp 12 has started emitting light. If it is judged that the various states have not reached the stage of preparation for emission, the routine returns to the processing of step P12 and the status values are reobtained. If it is judged that the preparations for emission are finished, the routine proceeds to the processing of step P14.

P14: The excitation voltage and excitation time corrected at step P6 are sent by the control circuit 11 to the high voltage power source 16 and/or switch 18 of the lamp lighting circuit 12. Based on this information, the high voltage power source 16 and/or switch 18 light up the ultraviolet flash lamp 12 for main emission of the ultraviolet flash lamp 12.

P15: The main emission of the ultraviolet flash lamp 12 is measured by the ultraviolet sensor 14. The result of the main emission of step P14 held as the sampled digital data V0 is obtained from the data holder 118 of the data holding means illustrated in FIG. 8A.

P16: The emission of the ultraviolet flash lamp 12 is confirmed. If light is not emitted, a warning is displayed. If light is emitted, the coating work is ended.

Second Control Method

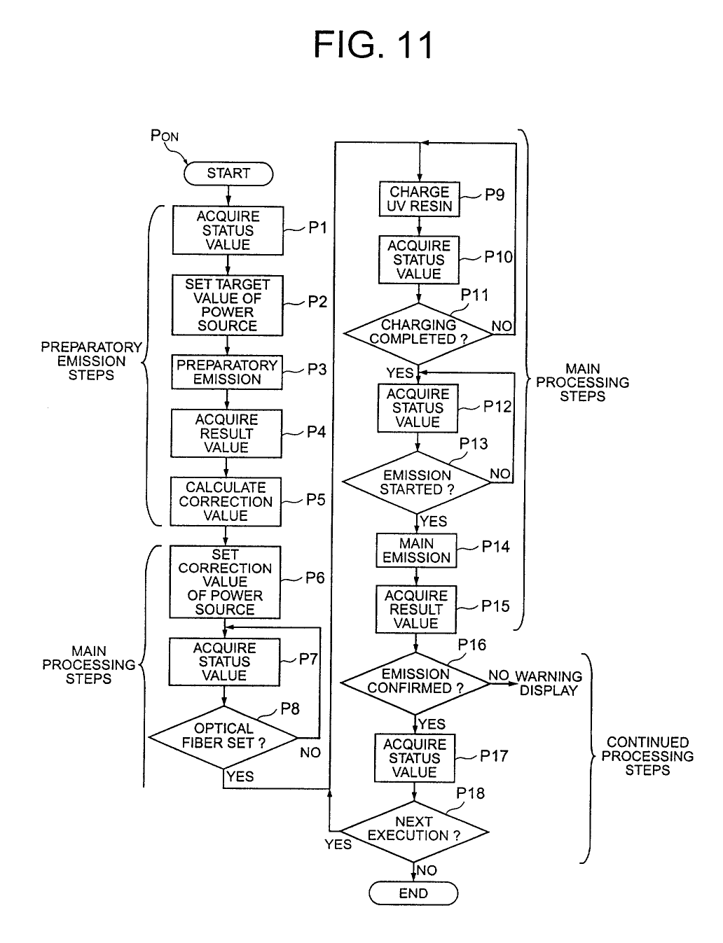

FIG. 11 is a flow chart of a second example of the operation of the optical fiber resin coating apparatus of the first embodiment of the present invention.

The second control method comprises performing preparatory emission once and making corrections when starting the optical fiber resin coating apparatus of the first embodiment, then continuing with the actual coating work.

Preparatory Emission Steps: P1 to P5

Substantially the same as the processing of the preparatory emission steps P1 to P5 explained with reference to FIG. 9.

Main Processing Steps: P6 to P16

Substantially the same as the processing of the main emission steps P6 to P16 explained with reference to FIG. 7. If it is judged at step P16 that the ultraviolet flash lamp 12 has emitted light, the routine proceeds to step P17.

Continued Work Processing: P17 to P18

P17: The various status values after emission of the ultraviolet flash lamp 12 are obtained from the control panel 15 and the I/Os of the various parts of the optical fiber resin coating apparatus.

P18: It is decided whether to perform coating work for the next optical fiber. If not performing coating, the optical fiber resin coating apparatus finishes operating. If performing the next coating, the routine returns to the processing of the main processing step P9. After finishing setting the optical fiber in the mold assembly 5, the ultraviolet curing resin is again charged and the coating work continued.

According to the second control method, the above continued work processing step is provided, so it is possible to perform coating work continuously and faster in addition to the advantageous effects of the first control method.

In the above control operation, a preparatory emission step is provided before each ultraviolet curing resin curing step. It is possible to further improve the accuracy of the adjustment of light and possible to stably coat the resin.

According to the first embodiment of the present invention, it is possible to provide an optical fiber resin coating apparatus of small dimensions. The small-sized optical fiber resin coating apparatus is superior in portability and for example is suitable when coating an optical fiber outdoors.

Further, according to the first embodiment of the present invention, it is possible to provide an optical fiber resin coating apparatus which uses a lamp lighting circuit which consumes little power and is small in structure.

Further, according to the optical fiber resin coating apparatus of the first embodiment of the present invention, it is possible to shorten the work time.

Further, according to the optical fiber resin coating apparatus of the first embodiment of the present invention, it is possible to coat an optical fiber with a high quality resin.

Second Embodiment

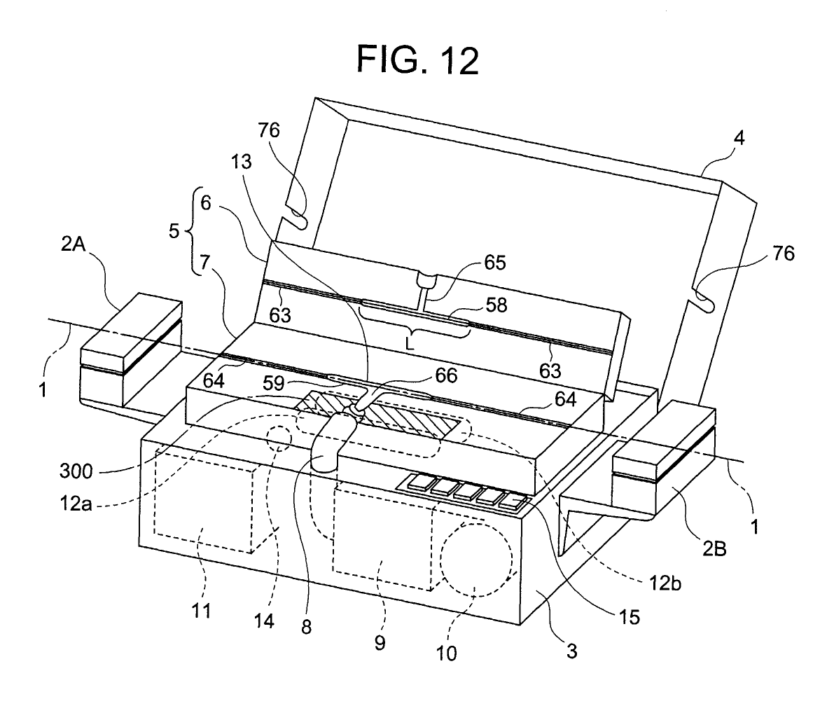

An optical fiber resin coating apparatus and method according to a second embodiment of the present invention will be explained next with reference to FIG. 12 to FIG. 27.

The second embodiment of the present invention blocks part of the ultraviolet light source, for example, half, by a light shield when controlling the curing of the coated portion of the ultraviolet curing resin to proceed gradually from one area to another.

By blocking half of the ultraviolet light source by the light shield, a penumbra phenomenon is created and light of an inclined profile pattern is irradiated on the recoating grooves. At this time, the light supply emits light intermittently to gradually cure the ultraviolet curing resin.

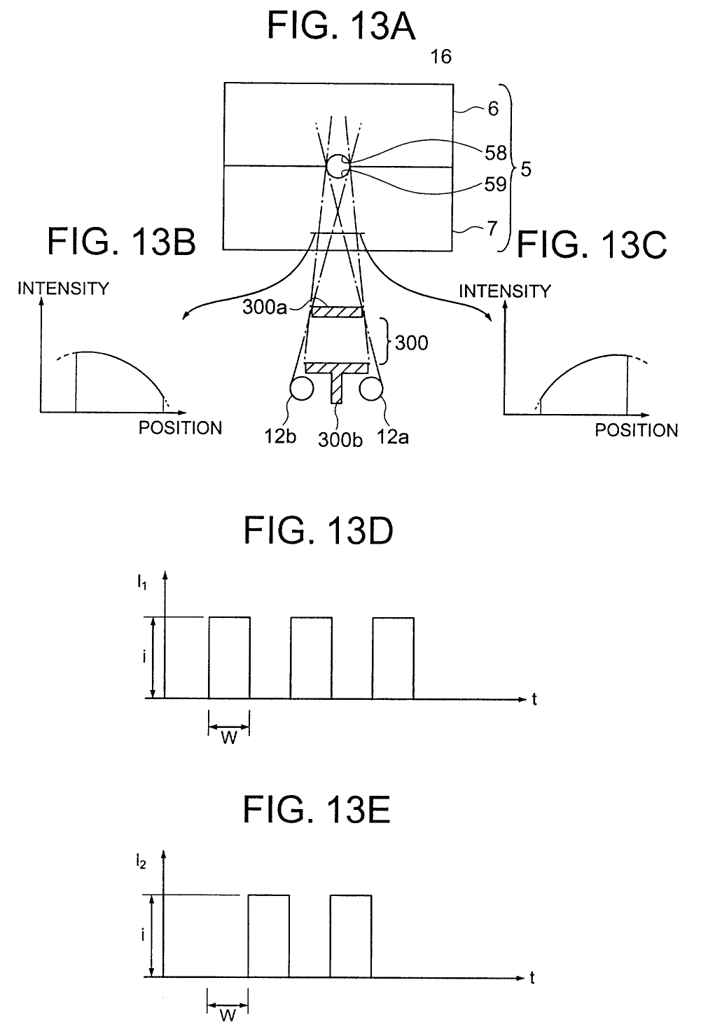

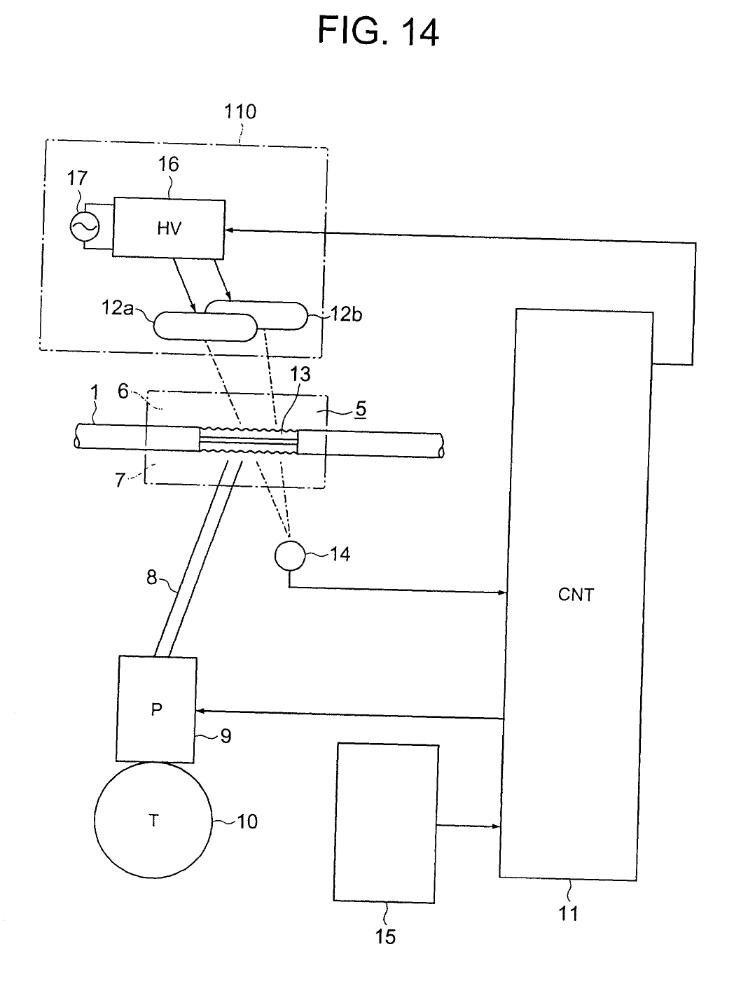

FIG. 12 is a perspective view of an optical fiber resin coating apparatus of the second embodiment of the present invention, FIG. 13A is a partial sectional view of FIG. 12, and FIG. 14 is a view of the control system.

The difference between the optical fiber resin coating apparatus illustrated in FIG. 12 and the optical fiber resin coating apparatus illustrated in FIG. 2 will be explained.

The optical fiber resin coating apparatus illustrated in FIG. 12 has ultraviolet light sources 12a and 12b comprised of two ultraviolet flash lamps placed inside the lower housing 3 and a light shield 300 for partially blocking light of the same. A mold assembly 5 having an upper mold 6 and a lower mold 7 formed of ultraviolet-transparent material is placed above the ultraviolet light sources 12a and 12b.

FIG. 13A illustrates the arrangement of the ultraviolet light sources 12a and 12b of the ultraviolet flash lamps and the light shield 300.

FIG. 14 illustrates the arrangement of the optical fiber 1 to be coated, ultraviolet light sources 12a and 12b, the mold assembly 5, and the ultraviolet sensor 14.

The ultraviolet light emitted from the ultraviolet light sources 12a and 12b and not blocked by the light shield 300 passes through the mold assembly 5, reaches the ultraviolet curing resin charged in the recoating grooves 58 and 59 of the lengths L formed at the centers of the upper mold 6 and lower mold 7, and cures the ultraviolet curing resin there.

FIG. 14 illustrates the control circuit 11, ultraviolet sensor 14, pump 9, tank 10, control panel 15, and lamp lighting circuit 110.

In the second embodiment, the ultraviolet light sources 12a and 12b having the ultraviolet flash lamps are both rod shaped (fluorescent lamp shaped). The two ultraviolet light sources 12a and 12b are arranged below the lower mold 7 in the mold assembly 5 in the same direction as the recoating groove 59 at equal distances from the recoating groove 59 and in parallel. The light shield 300 is for partially blocking the light of the ultraviolet light sources 12a and 12b to form penumbras and is arranged between the recoating groove 59 and ultraviolet light sources 12a and 12b.

The light shield 300 is comprised of elongated plates and is arranged to cover a range exceeding the area where the recoating groove 59 is arranged. As shown in FIG. 13A, the light shield 300 is comprised of an upper and lower stage. FIG. 13A is a view seen from the axial direction of the recoating grooves 58 and 59. The light shield 300 has an upper light shielding plate 300a and a lower light shielding plate 300b. The upper light shielding plate 300a and lower light shielding plate 300b are arranged in parallel facing each other.

The pair of ultraviolet light sources 12a and 12b are arranged in parallel under the lower light shielding plate 300b. They are disposed so that half of each is blocked by the lower light shielding plate 300b.

The synergistic effect with the upper light shielding plate 300a, the result of formation of the penumbras, and the profile of intensity of the ultraviolet light from the ultraviolet light sources 12a and 12b at the area inside the recoating grooves 58 and 59 are illustrated in FIG. 13B and FIG. 13C. With the ultraviolet light source 12a positioned at the right side facing the axial direction of the recoating grooves 58 and 59, the profile of intensity of the ultraviolet light at the area inside the recoating grooves 58 and 59 becomes weaker the more from the right to the left direction, while with the ultraviolet light source 12b positioned at the left side, the profile of intensity of ultraviolet light at the area inside the recoating grooves 58 and 59 becomes weaker the more from the left to the right direction.

Control by the control circuit 11 for lighting the ultraviolet light sources 12a and 12b comprises on the one hand supplying a pulse-like current illustrated in FIG. 13D and on the other hand supplying the pulse-like current illustrated in FIG. 13E. FIG. 13D shows an example of intermittently lighting the ultraviolet light sources three times by a constant current over a predetermined time, while FIG. 13E shows an example of intermittently lighting the ultraviolet light sources two times by a constant current over a predetermined time. In FIG. 13D and FIG. 13E, current is supplied at a staggered timing so that the lighted states do not simultaneously overlap to alternately light the ultraviolet light sources 12a and 12b comprised of the ultraviolet flash lamps.

The ultraviolet light sources 12a and 12b need only be alternately lighted up. The number of times they are lighted up is not limited to the above three times and two times.

As illustrated in FIG. 13D and FIG. 13E, the ultraviolet light sources 12a and 12b may be lighted up staggered so that their lighted states do not overlap and bubbles due to foam, gas, etc. in the ultraviolet curing resin may be gradually exhausted.

Lamp Lighting Circuit

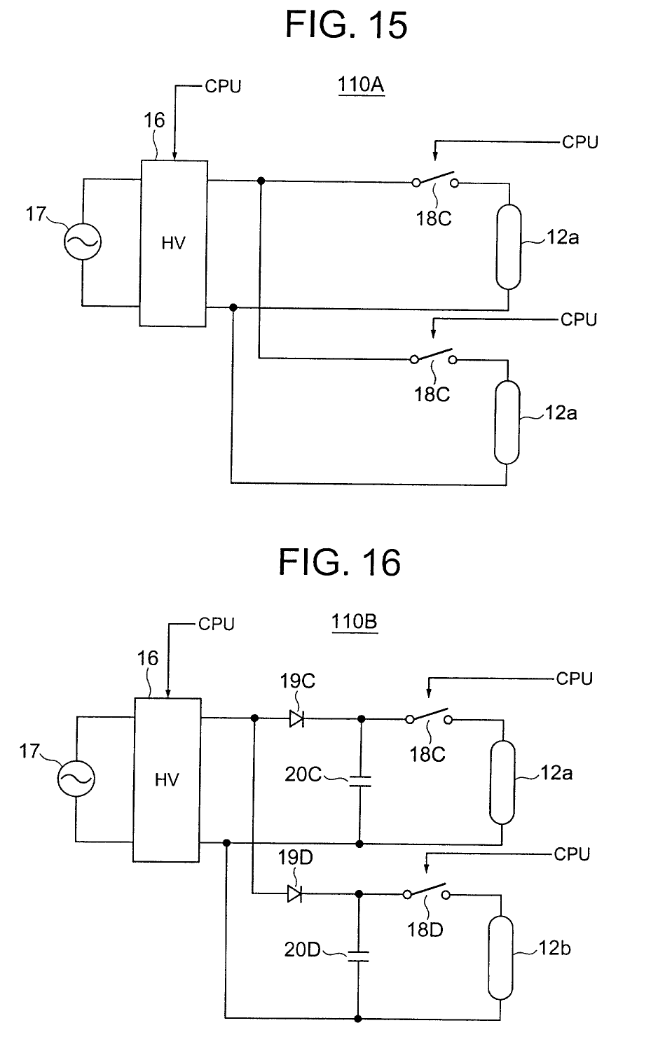

FIG. 15 and FIG. 16 show configurations of lamp lighting circuits illustrated as the lamp lighting circuit 110 in FIG. 14 for the control of lighting illustrated in FIG. 13D and FIG. 13E.

FIG. 15 is a view of the circuit configuration of the lamp lighting circuit 110A of a first example.

The lamp lighting circuit 110A has the primary power source 17, the high voltage power source 16, and first and second switches 18C and 18D.

The high voltage power source 16 is similar to the high voltage power source 16 explained with reference to FIG. 4 to FIG. 6 and is controlled by the control circuit 11. The switches 18C and 18D are also controlled by the control circuit 11.

The high voltage power source 16 includes for example a switching regulator for boosting the voltage of the primary voltage source 17 using an AC commercial power source to obtain a desired high voltage (for example, 75 to 400V). The ultraviolet light sources 12a and 12b are connected in parallel and supplied with power from the high voltage power source 16 in parallel. Further, switches 18C and 18D are arranged in the power feed paths of the ultraviolet light sources 12a and 12b. Of course, it is also possible to use a DC power source as the primary power source 17.

The switches 18C and 18D are controlled to open or close by the control circuit 11 by the pattern of FIG. 13D on the one hand and by the pattern of FIG. 13E on the other hand.

The current I of the power supplied to the ultraviolet light sources 12a and 12b, the lighting time length w, and the lighting interval can be made variable.

FIG. 16 is a view showing the circuit configuration of the lamp lighting circuit 100B of a second example.

The lamp lighting circuit 110B is an improvement designed to reduce the size of the high voltage power source 16 by storing the high voltage by diodes and capacitors as compared with the circuit configuration of the lamp lighting circuit 110A illustrated in FIG. 15. The ultraviolet light sources 12a and 12b are connected in parallel so that DC power from the high voltage power source 16 is supplied to them in parallel. The capacitors 20C and 20D are connected in parallel to the ultraviolet light sources 12a and 12b for storing charges, while the diodes 19C and 19D are connected in series in the forward direction in the power feed paths before the connection points of the capacitors 20C and 20D at the output side of the high voltage power source 16 for preventing reverse flow of the charges of the capacitors 20C and 20D. Switches 18C and 18D are arranged in the power feed paths of the ultraviolet light sources 12a and 12b after the connection points of the capacitors 20C and 20D.

The power from the high voltage power source 16 is stored through the diodes 19C and 19D in the capacitors 20C and 20D. Reverse flow is prevented by the diodes 19C and 19D. By closing the switches 18C and 18D, the charges stored in the capacitors 20C and 20D are supplied to the ultraviolet light sources 12a and 12b. While the switches 18C and 18D are open, the capacitors 20C and 20D store power from the high voltage power source 16, whereby the high voltage power source 16 can sufficiently meet the capacity requirements even if small in size.

The operation of the optical fiber resin coating apparatus of the second embodiment will be explained next.

The lid 4 is opened and the upper mold 6 of the mold assembly 5 opened to expose the lower mold 7. The coating formation portion 13 of the optical fiber 1 is arranged in the recoating groove 59, then the optical fiber 1 is firmly clamped by the clamps 2A and 2B and held down so as not to shift. Next, the mold assembly 5 is closed so that the upper mold 6 covers the lower mold 7, whereby the optical fiber 1 is positioned in the recoating grooves 58 and 59 of the upper mold 6 and lower mold 7, then the operator operates the injection button of the control panel 15. The control circuit 11 responds to this operation and starts the pump 9. The pump 9 operates to supply ultraviolet curing resin from the inside of the tank 10 to the pipe 8. The resin passes through the pipe 8 and is injected into the recoating grooves 58 and 59 in the upper mold 6 and lower mold 7 of the mold assembly 5.

The operator sets the amount of emission and instructs emission through the control panel 15, then the control circuit 11 controls the power source system to start up the high voltage power source 16 to generate a high voltage. When using the lamp lighting circuit 110A illustrated in FIG. 15, the current from the high voltage power source 16 is sent as it is to the ultraviolet light sources 12a and 12b through the switches 18C and 18D, while when using the lamp lighting circuit 110B of FIG. 16, it is sent after converting it to a direct current by passing it through the diodes 19C and 19D.

The switches 18C and 19D are controlled in operation by the control circuit 11 intermittently and alternately such as shown by FIG. 13D on the one hand and by FIG. 13E on the other hand, so the ultraviolet light sources 12a and 12b receiving the power turn ON or OFF in accordance with the switching pattern (intermittent lighting control). The states of emission of the ultraviolet light sources 12a and 12b are measured by the ultraviolet sensor 14 and given to the control circuit 11. The control circuit 11 compares the set value from the control panel 15 and measured value from the ultraviolet sensor 14, corrects the amounts of light of the ultraviolet light sources 12a and 12b to give the set value, and thereby adjusts the high voltage power supplied to the ultraviolet light sources 12a and 12b.

The ultraviolet light emitted by the ultraviolet light sources 12a and 12b is partially blocked by the light shield 300 and enters the recoating groove 59 at an incline from below the lower mold 7 in the mold assembly 5.

The light shield 300 is comprised of a vertical two-stage configuration of an upper light shielding plate 300a and lower light shielding plate 300b. The light shield 300 is arranged below the lower mold 7 and in the same direction as the recoating groove 59 at equal distances from and in parallel with the recoating groove 59. Therefore, the light from the ultraviolet light sources 12a and 12b arranged so that halves are blocked by the bottom of the vertical two-stage configuration passes through the light shield 300 forming the vertical two-stage configuration and enters the recoating grooves 58 and 59. At this stage, due to the effects of the penumbras, a profile of intensity of ultraviolet light as shown in FIG. 13B and FIG. 13C is formed.

The ultraviolet light passing through the lower mold 7 and reaching the recoating grooves 58 and 59 in the upper mold 6 and lower mold 7 cures the ultraviolet curing resin charged into the recoating grooves 58 and 59. The amount of ultraviolet light received in the recoating grooves 58 and 59 exhibits a vertically unbalanced profile of intensity, so the curing rate of the ultraviolet curing resin becomes faster in the area receiving a larger amount of ultraviolet light than the area receiving a lesser amount. That is, the curing proceeds gradually from one area to another area.

Therefore, the optical fiber 1 in the recoating grooves 58 and 59 is reinforced by the charged ultraviolet curing resin, but since the curing proceeds gradually from the bottom to the top, bubbles are pushed to the uncured side of the top center. As a result, the optical fiber is coated by ultraviolet curing resin free of bubbles.

In this way, in the second embodiment, when curing the ultraviolet curing resin, the curing is made to gradually proceed from one area to another to drive out the bubbles in the ultraviolet curing resin. Further, as a technique for gradually moving the curing area of the ultraviolet curing resin, penumbras are formed in the light of the ultraviolet light source. The penumbras are used to change the profile of intensity of the ultraviolet light from the ultraviolet light sources. Two ultraviolet light sources are used to intermittently irradiate the resin in a staggered fashion.

In the second embodiment, as illustrated in FIGS. 13A to 13C, the two ultraviolet light sources are arranged in parallel to the recoating groove 59. The penumbras are created by the light shield 300 arranged so as to block halves of the ultraviolet light sources. As shown by FIG. 13A, a view seen from the cross-section of the mold assembly 5, the ultraviolet light sources 12a and 12b are arranged in parallel to the recoating groove 58 and recoating groove 59 of the upper mold 6 and lower mold 7 forming the mold assembly 5. They are arranged so that the penumbra phenomenon is created by the upper light shielding plate 300a and lower light shielding plate 300b forming the light shield 300.

The penumbras created by the ultraviolet light sources 12a and 12b and the upper light shielding plate 300a and lower light shielding plate 300b irradiate the recoating grooves 58 and 59 from below. The penumbras created by the ultraviolet light sources 12a and 12b are inclined reverse from each other as shown in FIG. 13B and FIG. 13C. Further, the ultraviolet light sources 12a and 12b are lighted up intermittently by the control circuit 11 as shown in FIG. 13D and FIG. 13E for example. By alternate irradiation, the ultraviolet curing resin is gradually cured from the bottom of the recoating groove 59 so as to drive the gas or bubbles in the ultraviolet curing resin to the recoating groove 58 side.

While not shown in the drawing, for example, if providing a gas trap or forming a gas vent in the recoating groove 58 of the upper mold 6 of the mold assembly 5, it is possible to smoothly remove the gas or bubbles from the ultraviolet curing resin in the recoating grooves 58 and 59. As a result, when recoating a portion of an optical fiber stripped of the coating by the ultraviolet curing resin, it becomes possible to recoat it without leaving bubbles in the ultraviolet curing resin.

First Modification of Second Embodiment

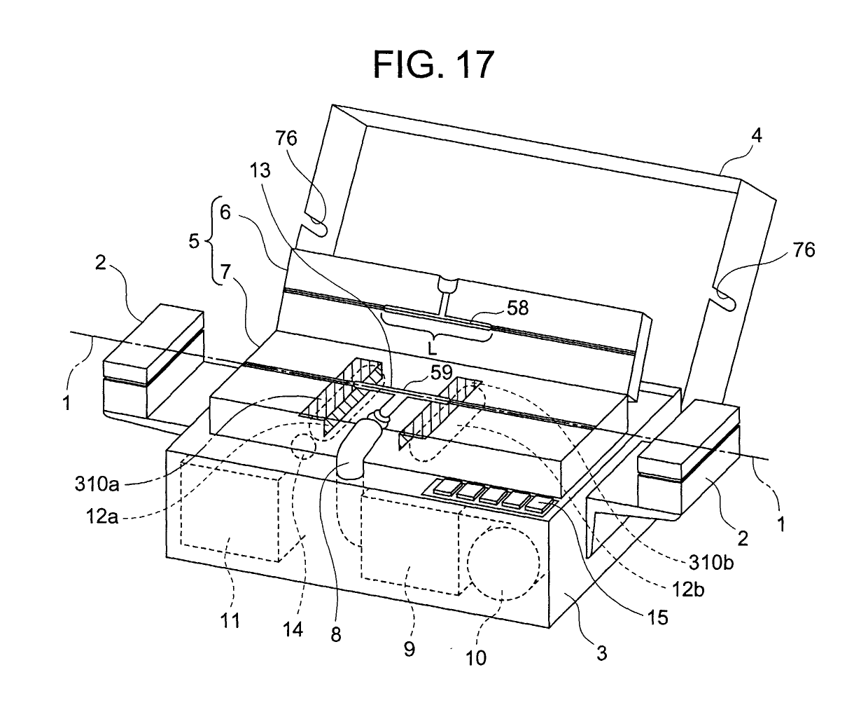

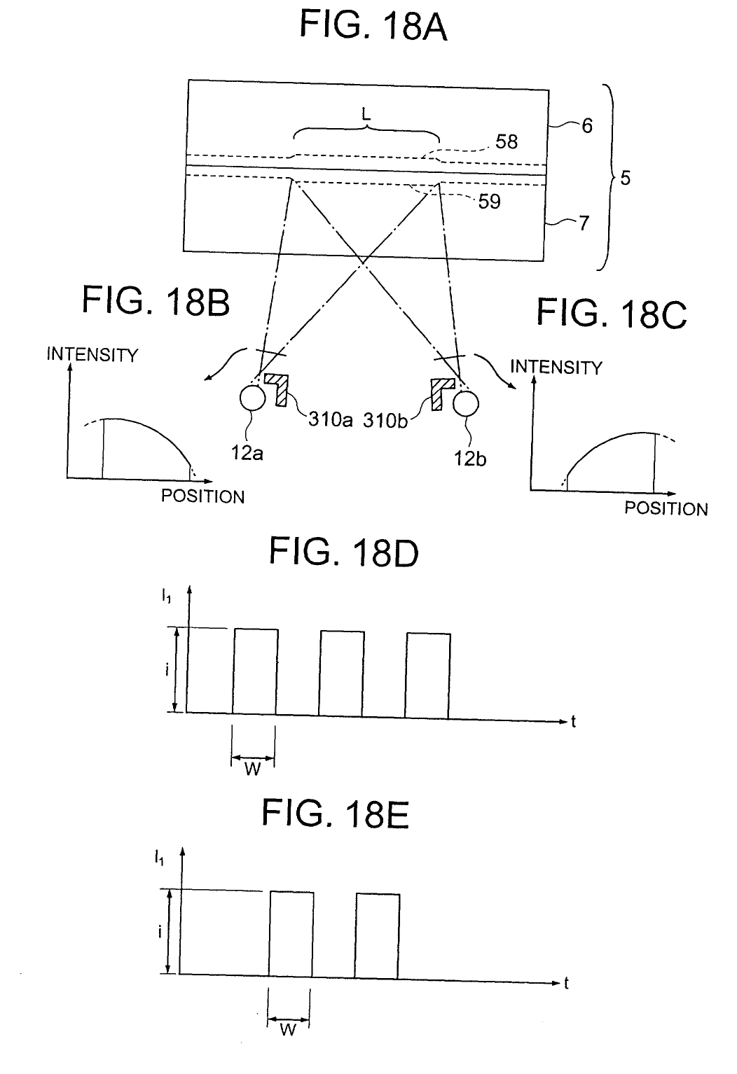

A first modification of the second embodiment of the present invention using the penumbra phenomenon and intermittent emission will be explained next referring to FIG. 17 and FIGS. 18A to 18E.

The first modification of the second embodiment differs from the second embodiment in the point of arranging the pair of ultraviolet light sources 12a and 12b to intersect the recoating grooves 58 and 59.

FIG. 18A is a view of principal parts seen from the front of a mold assembly 5. The mold assembly 5 is comprised of an upper mold 6 and a lower mold 7. These are formed with the recoating groove 58 and recoating groove 59.

The ultraviolet light source 12a and ultraviolet light source 12b are arranged at the bottom close to the front and rear ends of the long recoating groove 59 in a direction intersecting the recoating grooves 58 and 59. The ultraviolet light sources 12a and 12b are half blocked by the long light shielding plates 310a and 310b of the inverted L-sectional shapes. By providing the light shielding plates 310a and 310b in a manner blocking halves of the ultraviolet light sources 12a and 12b, a penumbra phenomenon of the light from the ultraviolet light sources 12a and 12b occurs at the position of the recoating grooves 58 and 59. Due to the penumbras created by the light shielding plates 310a and 310b from the ultraviolet light sources 12a and 12b, the recoating grooves 58 and 59 receive ultraviolet light of a profile of intensity forming fan-shapes of reverse inclinations as shown in FIG. 18B and FIG. 18C.

In the same way as the second embodiment, the first modification of the second embodiment controls the ultraviolet light sources 12a and 12b to light up as shown in FIG. 18D on the one hand and as shown in FIG. 18E on the other hand in the same way as explained with reference to FIG. 13D and FIG. 13E. FIG. 18D shows an example of intermittently lighting up the ultraviolet light sources three times by a constant current over a predetermined time, while FIG. 18E shows an example of intermittently lighting up the ultraviolet light sources two times by a constant current over a predetermined time. In FIG. 18D and FIG. 18E, the ultraviolet light sources are lighted up staggered so that the lighted states do not simultaneously overlap.

In the first modification of the second embodiment as well, it is possible to use any of the lamp lighting circuits illustrated in FIG. 15 and FIG. 16.

By lighting the ultraviolet light sources 12a and 12b intermittently as shown for example in FIG. 18D and FIG. 18E to alternately irradiate the ultraviolet curing resin injected into the recoating grooves 58 and 59 by ultraviolet light and gradually cure it from the bottom of the recoating groove 59, the gas or bubbles are driven to the recoating groove 58 side. That is, the resin is cured from the two ends of the ultraviolet coating formation portion 13 to push the gas or bubbles to the center. Since the ultraviolet light is irradiated from the bottom of the recoating groove 59, the higher the layer, the slower the curing. Therefore, the gas and bubbles gather at the top of the center of the recoating groove 58. If providing a not shown gas trap or gas vent at the center of the recoating groove 58 and removing the gas or bubbles from the recoating groove, when recoating a portion of the optical fiber 1 from which the coating has been stripped, it becomes possible to recoat it without leaving any bubbles in the ultraviolet curing resin.

Second Modification of Second Embodiment

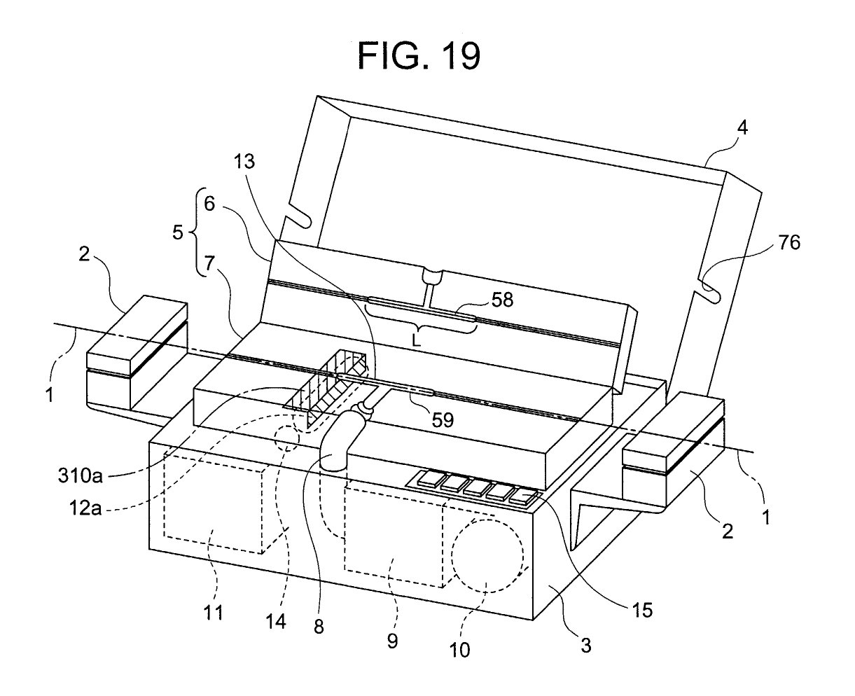

A second modification of the second embodiment of the present invention using the penumbra phenomenon and intermittent emission will be explained next referring to FIG. 19 to FIG. 21.

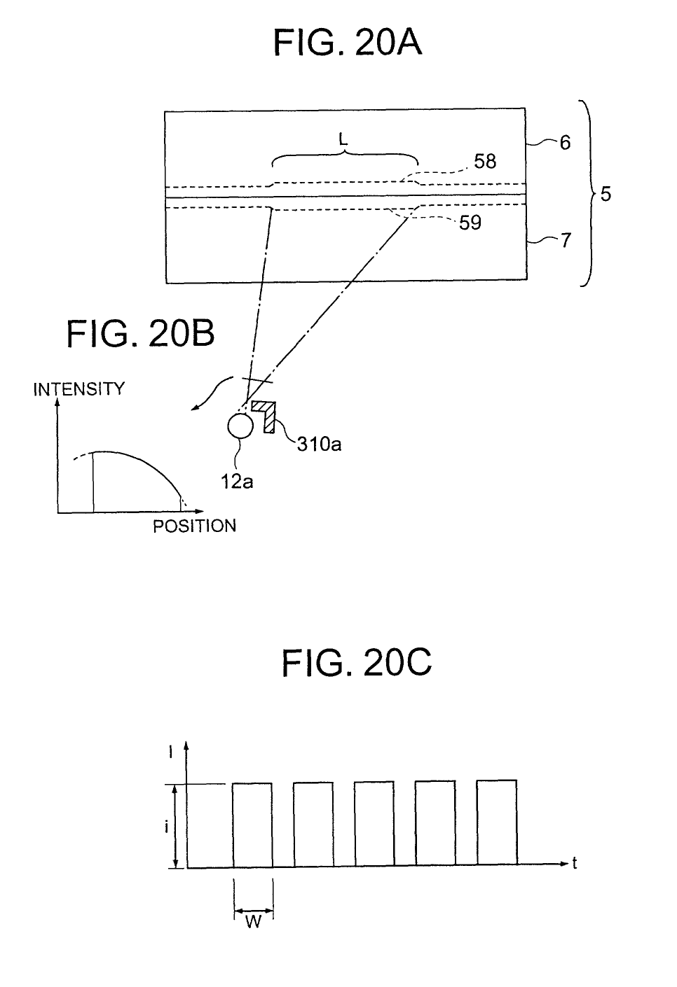

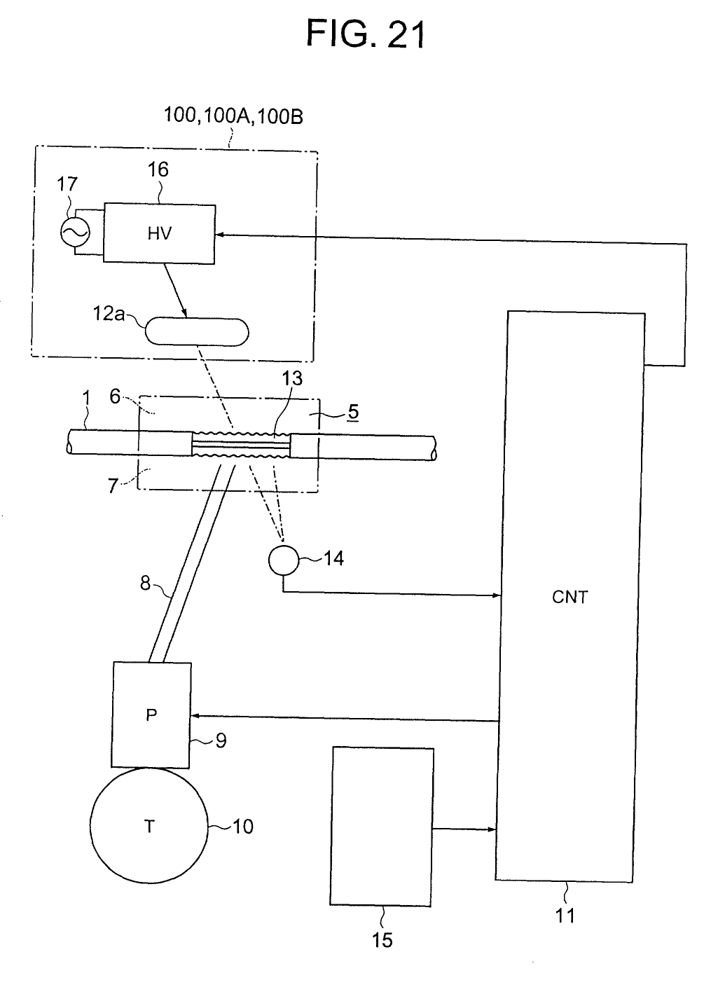

FIG. 19 is a perspective view of an optical fiber resin coating apparatus of the second embodiment of the present invention, FIG. 20A is a partial sectional view of FIG. 19, and FIG. 21 is a view of the control system.

In the second modification, one ultraviolet light source is used. That is, it is comprised removing one of the above two ultraviolet light sources 12a and 12b to leave a single ultraviolet light source. In the figure, the ultraviolet light source 12b is removed to leave the ultraviolet light source 12a. Therefore, there is only the light shielding plate 310a and no light shielding plate 310b.

FIG. 20A is a view of principal parts of the mold assembly 5 seen from the front. The mold assembly 5 is comprised of an upper mold 6 and lower mold 7. These are formed with a recoating groove 58 and recoating groove 59 over their lengths L.

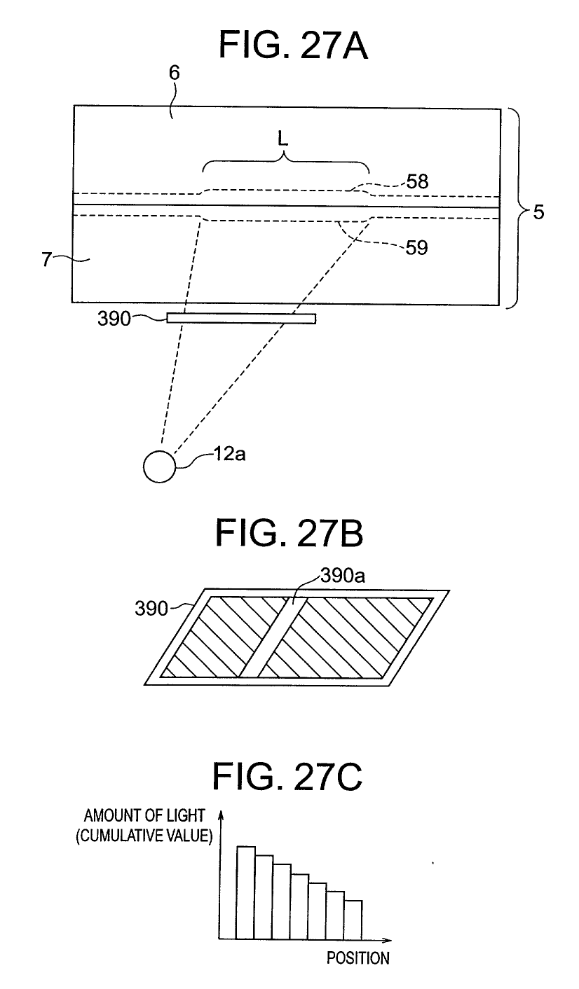

The ultraviolet light source 12a is arranged at the bottom close to one end of the range of the long recoating groove 59 extending over the length L in a direction intersecting the recoating grooves 58 and 59. The ultraviolet light source 12a is half blocked by the long light shielding plate 310a with a reverse L-shaped sectional shape. By providing the light shielding plate 310a at the ultraviolet light source 12a in a manner blocking half of it, a penumbra phenomenon of the light from the ultraviolet light source 12a occurs at the position of the recoating grooves 58 and 59. By the penumbra created by the light shielding plate 310a from the ultraviolet light source 12a, the recoating grooves 58 and 59 receive ultraviolet light of a profile of intensity forming a fan-shaped inclination as shown in FIG. 27B.

The ultraviolet light source 12a is controlled to light up as shown in FIG. 20C. That is, the control circuit 11 lights it up intermittently by a constant current over a predetermined time.

As the lamp lighting circuit 100 illustrated in FIG. 21, it is possible to use any of the lamp lighting circuits explained with reference to FIG. 4 to FIG. 6.

For example, the lamp lighting circuit 100 illustrated in FIG. 4 has a primary power source 17, a high voltage power source 16 having a switch regulator, and a switch 18. The control circuit 11 controls the output voltage of the high voltage power source 16. The control circuit 11 turns the switch 18 ON or OFF at the timing of FIG. 20C to control the ultraviolet light source 12a of the ultraviolet flash lamp to light up.

The ultraviolet light emitted from the ultraviolet light source 12a is partially blocked by the light shielding plate 310a to create a penumbra. As a result, the profile of intensity at the recoating groove 59 over the length L becomes that as shown in FIG. 27b. The further from the position of the ultraviolet light source 12a, the smaller the intensity of the ultraviolet light received.

By controlling power intermittently as shown in FIG. 20C by any of the lamp lighting circuits illustrated in FIG. 4 to FIG. 6 under the control of the control circuit 11 to light up the ultraviolet light source 12a, it is possible to gradually cure the ultraviolet curing resin in the recoating grooves 58 and 59 from the bottom of one end of the recoating groove 59. Further, by gradually curing the ultraviolet curing resin from the bottom of one end of the recoating groove 59, it is possible to drive the gas or bubbles in the ultraviolet curing resin to the top of the other end of the recoating groove 58. By gradually curing the ultraviolet curing resin from one end to push the gas or bubbles to the other end, the bubbles in the ultraviolet curing resin are moved. By providing a not shown gas trap in the recoating groove 58 or providing a gas vent, it is possible to remove the gas or bubbles from the recoating grooves. According to this configuration, it is possible to vent the gas or bubbles of the ultraviolet curing resin by a single ultraviolet light source and possible to streamline the configuration to reduce the cost.

Third Modification of Second Embodiment

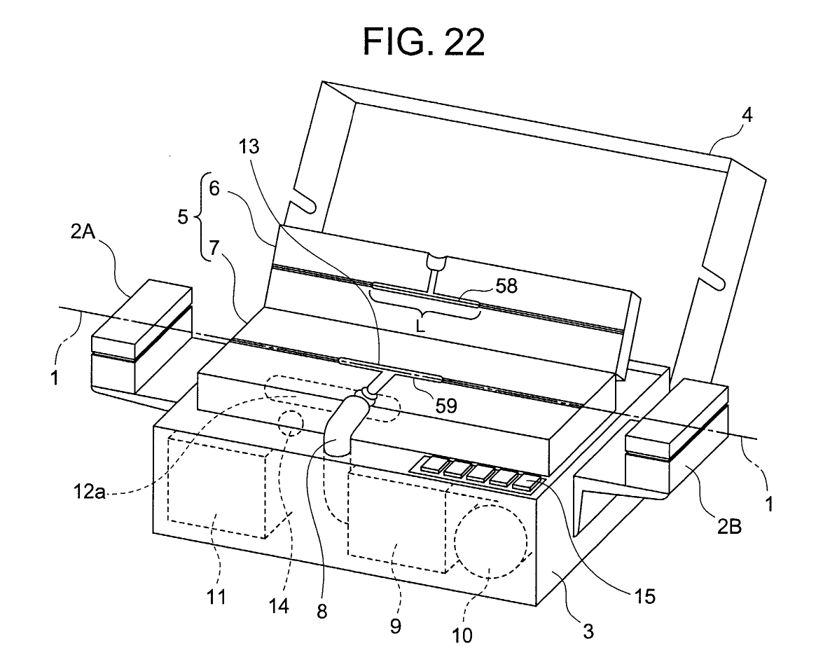

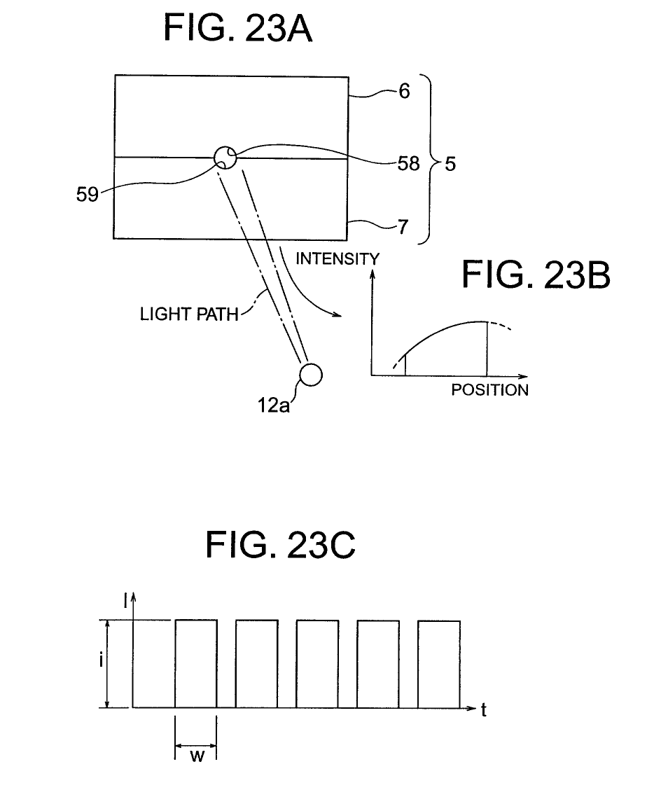

A third modification of the second embodiment of the present invention using the penumbra phenomenon and intermittent emission will be explained with reference to FIG. 22 and FIGS. 23A to 23C.

FIG. 22 is a perspective view of an optical fiber resin coating apparatus of the third modification of the second embodiment of the present invention.

This embodiment cures the ultraviolet curing resin gradually from one area to another even without using a penumbra. Therefore, the light shielding plate 310a is eliminated. In the case of the second modification, a single ultraviolet light source was used, but the penumbra was used to change the profile of intensity of the ultraviolet light. In the present modification, rather than using a penumbra, the position of the single ultraviolet light source 12a with respect to the recoating grooves 58 and 59 and the intermittent lighting are used to obtain an inclined profile where the intensity of the ultraviolet light in the recoating grooves 58 and 59 differs depending on the position.

FIG. 23A is a view of the configuration of principal parts of the mold assembly 5 seen from the cross-section. The mold assembly 5 comprises an upper mold 6 and a lower mold 7. The recoating groove 58 and the recoating groove 59 are formed across the lengths L.

The ultraviolet light source 12a is arranged at the bottom near one end of the area of the long recoating groove 59 extending over the length L in a direction parallel to the recoating grooves 58 and 59, but there is no light shielding plate for creating a penumbra. The distance between different positions in the longitudinal direction at the recoating grooves 58 and 59 and ultraviolet light source 12a differs due to the offset of the position of the ultraviolet light source 12a. Due to the difference in distance, the distance which the ultraviolet light covers differs, so the profile of intensity of the ultraviolet light received differs corresponding to the distance.

Looking at the cross-sectional direction of the recoating grooves 58 and 59 as well, the distance also changes the further from the center position of the recoating grooves 58 and 59 to the direction of the peripheral positions. Thus, ultraviolet light of a profile of intensity giving a fan-shaped inclination shown in FIG. 23B is received.

In this embodiment, the ultraviolet light source 12a is controlled by the control circuit 11 to light up as shown in FIG. 23C. That is, it is lit intermittently by a constant current over a predetermined period. As the lamp lighting circuit for this, it is possible to use any of the circuits explained with reference to FIG. 4 to FIG. 6.

As shown in FIG. 22 and FIGS. 23A to 23C, a single ultraviolet light source 12a is arranged parallel to the recoating groove 59. The ultraviolet light source 12a is offset to one end in the range of the length L of the recoating groove 59 and is arranged in the vertical direction as well not directly under the recoating groove 59, but offset from it. That is, the ultraviolet light source 12a is arranged below the recoating groove 59 at an incline, so looking at the range of the length L of the recoating groove 7a, the profile of intensity of the ultraviolet light becomes lower the further from the ultraviolet light source 12a. That is, an inclined profile is exhibited.

The ultraviolet light source 12a is lit as explained above by controlling the power intermittently. Due to this, it is possible to gradually cure the ultraviolet curing resin in the recoating grooves 58 and 59 from the bottom of one end of the recoating groove 59.

By gradually curing the ultraviolet curing resin from the bottom of one end of the recoating groove 59, it is possible to drive the gas or bubbles in the ultraviolet curing resin to the top of the other end of the recoating groove 58. In this way, the ultraviolet curing resin is gradually cured from one end to push the gas or bubbles to the other end so as to move the bubbles in the ultraviolet curing resin. By providing a not shown gas trap or providing a gas vent in the recoating groove 58, it is possible to remove the gas or bubbles from the recoating groove. According to this, it is possible to vent the gas or bubbles of the ultraviolet curing resin by a single ultraviolet light source and therefore possible to streamline the configuration and reduce the cost more.

In this way, even without using a penumbra, it is possible to gradually cure the ultraviolet curing resin from one area to another.

Fourth Modification of Second Embodiment

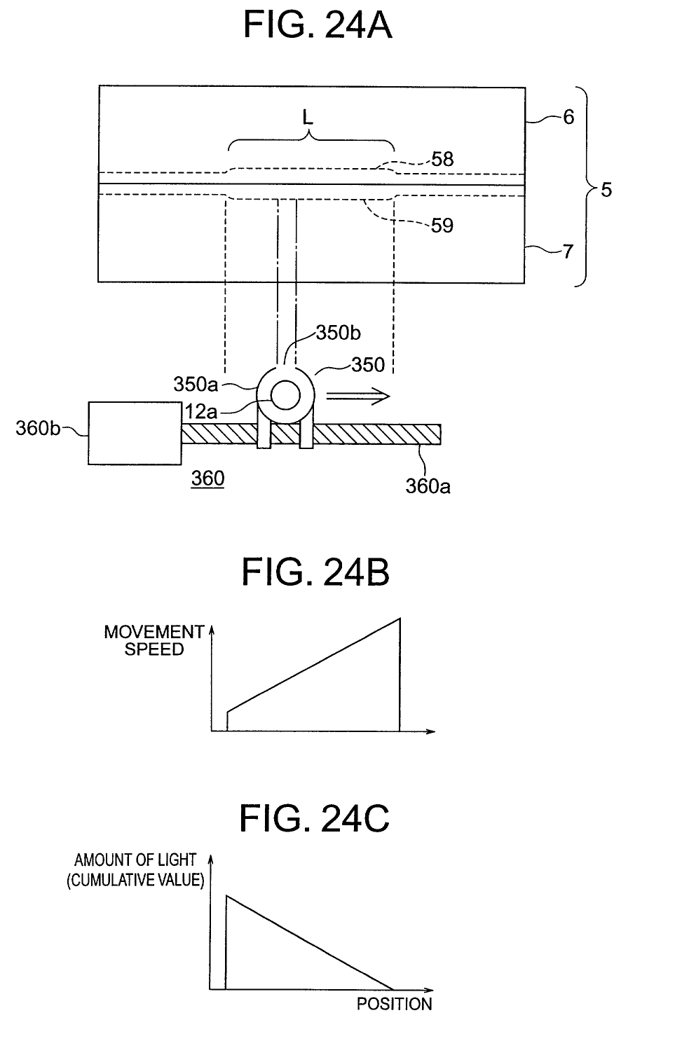

A fourth modification of the second embodiment of the present invention using the penumbra phenomenon and intermittent emission will be explained next with reference to FIGS. 24A to 24C.

This embodiment is designed to move the ultraviolet light source 12a instead of generating the inclined profile and to change the amount of emission by changing the speed of movement.

FIG. 24A is a view of the mold 5 assembly seen from the front. The optical fiber resin coating apparatus of this embodiment has a projector 350. This projector 350 holds the ultraviolet light source 12a in a light blocking container 350a provided with a slit 350b and emits light through the slit 350b. Due to this, it can focus a spot of light on the recoating grooves 58 and 59. Note that the inside of the light blocking container 350a may also be given a mirror finish.

The projector 350 is configured to be able to move in parallel by a drive mechanism 360 along the longitudinal direction of the recoating grooves 58 and 59 in the upper mold 6 and lower mold 7 forming the mold assembly 5. The drive mechanism 360 is comprised of a lead screw (or ball screw) 360a and a motor 360b for driving the forward and reverse rotation of the lead screw 360a. The projector 350 is provided with a female thread which engages with the lead screw 360a so that the projector moves along with rotation of the lead screw 360a. Due to this, the projector 350 can move back and forth along the axial direction of the lead screw 360a in accordance with rotation of the lead screw 360a.

In FIG. 24A, there is used a linear stage for moving the lead screw (or ball screw) by rotation by the motor, but it is also possible to employ another method so long as the projector can be moved parallelly.

By driving the rotation of the motor 360b of the drive mechanism 360, the projector 350 is moved in parallel along the longitudinal direction of the recoating grooves 58 and 59 in the upper mold 6 and lower mold 7 forming the mold assembly 5.

When the projector 350 is at the left end position of the range of the length L in FIG. 24A, the ultraviolet light source 12a is lit and the motor 360b is gradually increased in speed from the low speed rotation state to the high speed rotation state. The projector 350 is configured to project ultraviolet light emitted from the ultraviolet light source 12a held in the light blocking container 350a through the slit 350b so as to focus a spot of light on the recoating grooves 58 and 59 while moving toward the right end gradually increasing in speed.

The speed of movement is as shown in FIG. 24B. As a result, the amount of the ultraviolet light in the recoating grooves 58 and 59 becomes the value illustrated in FIG. 24C. That is, the profile of intensity of the ultraviolet light becomes an inclined pattern. Due to this, the curing speed of the ultraviolet curing resin changes according to the position. Since the gas and bubbles are driven to the uncured area, when the optical fiber 1 in the recoating grooves 58 and 59 is reinforced by the injected ultraviolet curing resin, it is coated by ultraviolet curing resin free of bubbles. Note that at a fast speed position, when the amount of the ultraviolet light is insufficient for curing the ultraviolet curing resin, the operation may be repeated.

In this way, the apparatus is structured to move the ultraviolet light source. Even if making the speed of movement variable, advantageous effects similar to the above are exhibited.

Fifth Modification of Second Embodiment

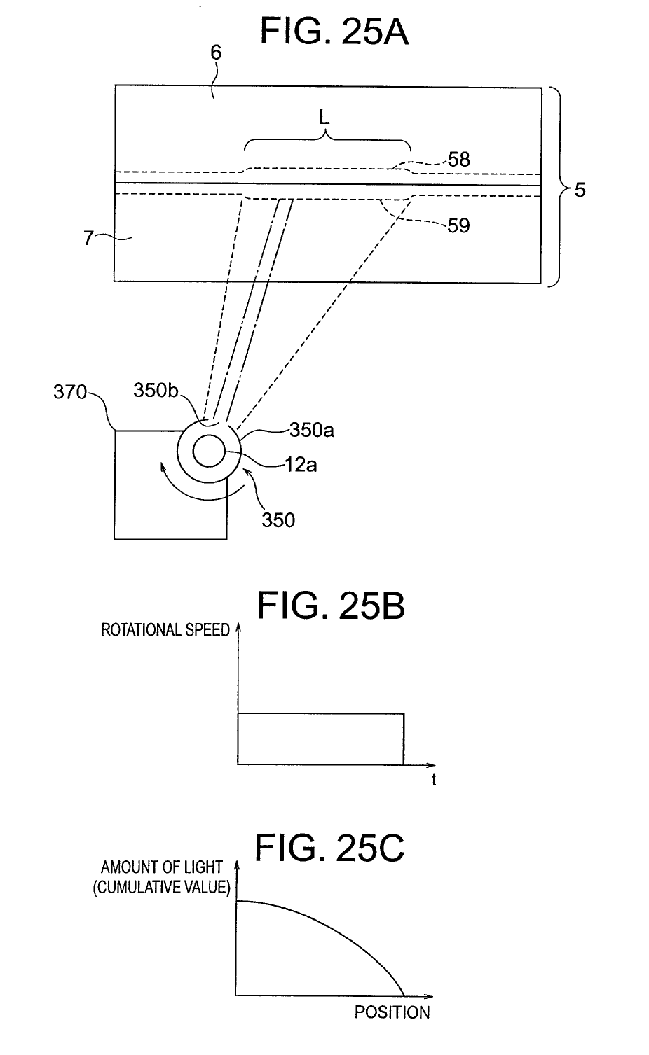

A fifth modification of the second embodiment of the present invention using the penumbra phenomenon and intermittent emission will be explained next with reference to FIGS. 25A to 25C.

This modification is structured to move the ultraviolet light source by a variable speed, makes the ultraviolet light source scan in sectors (fan-shaped scan), and makes the speed of movement of the sector scan variable.

FIG. 25A is a view showing the mold assembly 5 of the optical fiber resin coating apparatus as seen from the front. The optical fiber resin coating apparatus of this embodiment has a projector 350. The projector 350 holds the ultraviolet light source 12a in a light blocking container 350a provided with a slit 350b and emits light through the slit 350b. Due to this, it can focus a spot of light on the recoating grooves 58 and 59. The inside of the light blocking container 350a may also be given a mirror finish.

The projector 350 is held so as to be able to be pivoted and is operated to be driven to rotate by a sector drive mechanism 370 using a motor at a constant speed with a direction of the slit 350b in a predetermined range of elevation.

The sector drive mechanism 370 is arranged for example at an angle to the left below the recoating grooves 58 and 59 in the upper mold 6 and lower mold 7 forming the mold assembly 5. The projector 350 is held by the sector drive mechanism 370 so that the direction of the slit 350b is in a predetermined range of elevation and the projector can pivot at a constant speed as shown in FIG. 25B.

The range of distribution of the recoating grooves 58 and 59 extends in the longitudinal direction of the length L and can focus a spot of light by the sector scan.

The light from the projector 350 is arranged at the bottom near one end of the area of the long recoating groove 59 extending over the length L and forms a spot of light on the recoating grooves 58 and 59. The further from the projector 350 in the range of the length L, the longer the light path from the projector 350. Therefore, the profile of intensity of the ultraviolet light striking the recoating grooves 58 and 59 in a spot by the sector scan becomes as shown in FIG. 25C. The further the position, the smaller the fan-shaped profile that is obtained.

Therefore, the recoating grooves 58 and 59 receive ultraviolet light of a profile of intensity giving a fan-shaped inclination. Due to this, the curing speed of the ultraviolet curing resin changes according to the position. Since the gas and bubbles are driven to the uncured area, when the optical fiber 1 in the recoating grooves 58 and 59 is reinforced by the injected ultraviolet curing resin, it is coated by ultraviolet curing resin free of bubbles. Note that at a fast speed position, when the amount of the ultraviolet light is insufficient for curing the ultraviolet curing resin, the operation may be repeated.

In the example illustrated in FIG. 25C, a sector drive mechanism for pivoting the projector by a motor was used, but it is also possible to use another mechanism for the pivoting action.

Sixth Modification of Second Embodiment

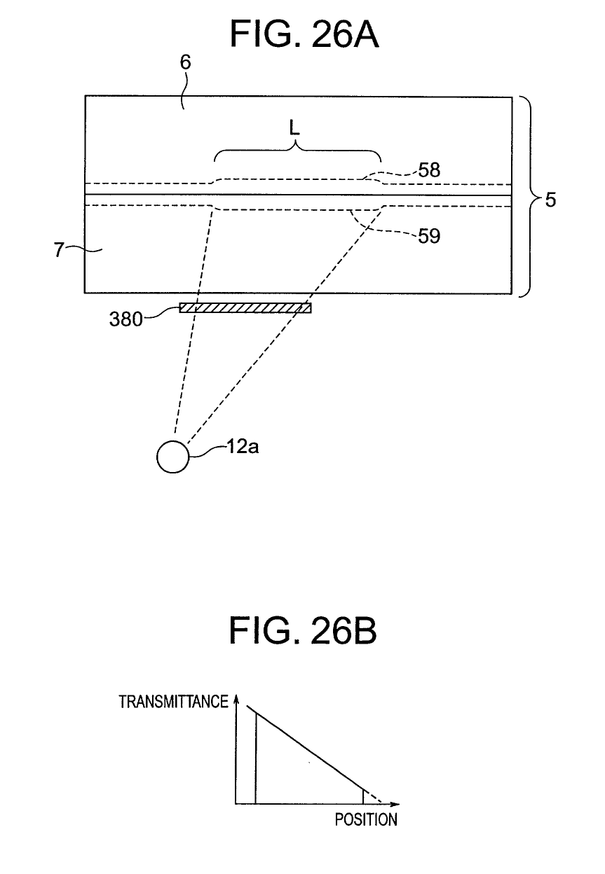

A sixth modification of the second embodiment of the present invention using the penumbra phenomenon and intermittent emission will be explained next with reference to FIGS. 26A to 26B.

Employing an optical filter 380 of an inclined profile may be realized.

FIG. 26A is a view of the mold assembly 5 as seen from the front. The optical filter 380 has the feature of an inclined transmittance of ultraviolet light as shown in FIG. 26B.

The ultraviolet light source 12a is arranged for example at an angle below the left end of the recoating grooves 58 and 59 in the upper mold 6 and lower mold 7 forming the mold assembly 5. The optical filter 380 extends over the range of length L of the recoating grooves 58 and 59. The light of the ultraviolet light source 12a is made to pass through this optical filter 380 and enter the recoating grooves 58 and 59 by arranging the filter in parallel to the recoating groove 59 at a position below the recoating groove 59.

The ultraviolet light from the ultraviolet light source 12a entering the recoating grooves 58 and 59 is adjusted in transmittance by the optical filter 380 and forms an inclined profile of intensity in accordance with the profile of transmittance as shown for example in FIG. 26B.

The recoating grooves 58 and 59 receive the ultraviolet light of the profile of intensity forming the inclined profile. Due to this, the curing speed of the ultraviolet curing resin changes depending on the position and the gas and bubbles are driven to the uncured area. Therefore, when reinforced by the injected ultraviolet curing resin, the optical fiber 1 in the recoating grooves 58 and 59 is coated by an ultraviolet curing resin with no bubbles.

Seventh Modification of Second Embodiment

A seventh modification of the second embodiment of the present invention using the penumbra phenomenon and intermittent emission will be explained next with reference to FIGS. 27A to 27C.

This embodiment is configured to use a shutter 390 enabling movement of the opening position instead of the optical filter 380 of the inclined profile illustrated in FIG. 26A. As the shutter 390, it is possible to use a liquid crystal shutter or mechanical shutter for example.

FIG. 27A is a view of the mold assembly 5 seen from the front. The shutter 390, as illustrated in FIG. 27B, has a slit-shaped opening 390a. This opening 390a is slidable. Further, the control circuit 11 controls the system so that the change in the cumulative value of the amount of light emitted intermittently while gradually increasing the speed of movement of the opening position of the shutter 390 becomes inclined as illustrated in FIG. 27C.

The opening time of the shutter 390 for each change of the opening position is given an incline so as to make the cumulative value of the ultraviolet light from the ultraviolet light source 12a incline. Therefore, the recoating grooves 58 and 59 receive the ultraviolet light of a profile of intensity forming the inclined profile. Due to this, the curing speed of the ultraviolet curing resin changes depending on the position and the gas and bubbles are driven to the uncured area. When reinforced by the injected ultraviolet curing resin, the optical fiber 1 in the recoating grooves 58 and 59 is thus coated by an ultraviolet curing resin with no bubbles.

In this way, according to the second embodiment, rather than injecting the ultraviolet curing resin into the ultraviolet resin mold assembly and irradiating that injected resin by the ultraviolet light emitted from an ultraviolet light source to cure it as in the past, the resin is cured by using an inclined profile of ultraviolet light to drive the gas or bubbles to the uncured area and bubbles due to foam or gas never end up remaining in the solidified ultraviolet curing resin. Further, the problem of an insufficient strength of the location of the coating of the ultraviolet curing resin where bubbles ended up occurring is solved.

Third Embodiment

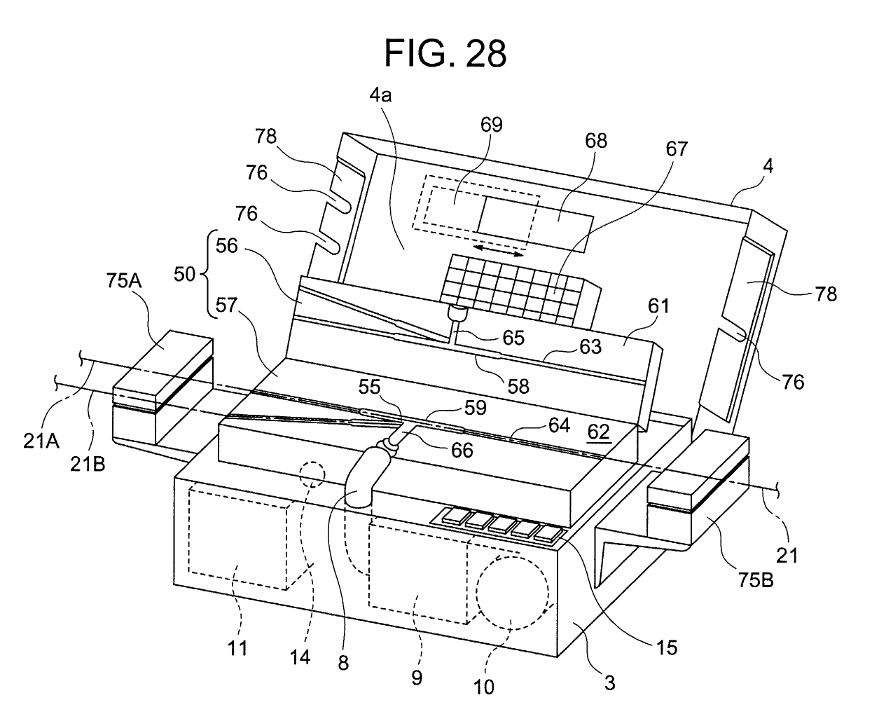

An optical fiber resin coating apparatus and method according to a third embodiment of the present invention will be explained next with reference to FIG. 28 to FIG. 31.

The third embodiment relates to an optical fiber resin coating apparatus and method used when coating the coating formation portions of two optical fibers fused together after stripping the coating from the optical fibers.

The optical fiber resin coating apparatus illustrated in FIG. 28 is provided with a lower housing 3 containing a mold assembly 50, an upper lid 4 attached pivotally to the lower housing 3 and able to shield the mold assembly 50 from outside light, and an ultraviolet light source 67 attached to the inside of the upper lid 4.

In the optical fiber resin coating apparatus illustrated in FIG. 28, an ultraviolet curing resin is charged into the mold assembly 50 in which the coating formation portions 55 of the two optical fibers 21A and 21B clamped by the clamp 75 are set. The charged ultraviolet curing resin is irradiated by ultraviolet light to cure it and coat the coating formation portions 55 by the ultraviolet curing resin.

The upper lid 4 is a box shape with a bottom opening. When the upper lid 4 is closed, a dark box is formed with the lower housing 3.

The lower housing 3 has a built-in control panel 15, a tank 10 storing the ultraviolet curing resin, and a pump 9 pumping up the ultraviolet curing resin from the tank 10. The pipe 8, pump 9, tank 10, control circuit 11, ultraviolet sensor 14, and control panel 15 are similar to those in the optical fiber resin coating apparatus of the above embodiments.

In this embodiment, an ultraviolet light source 67 is used instead of the above ultraviolet flash lamp 12.

The mold assembly 50 is comprised of a lower mold 57 made of silica glass affixed to the upper surface of the lower housing 3 and an upper mold 56 made of silica glass attached pivotally to the lower mold 57.

The centers of the mating surfaces of the upper mold 56 and lower mold 57 (lower surface 61 of upper mold 56 and upper surface 62 of lower mold 57) are formed with long grooves 58 and 59 with semicircular cross-sectional shapes able to receive the coating formation portions 55 of the optical fibers 21A and 21B (hereinafter called “recoating grooves”). After the coating formation portions 55 are fit into the recoating groove 59 of the lower mold 57, the upper mold 56 is placed over the lower mold 57 to join the connection surfaces together, whereby the recoating grooves 58 and 59 formed in the connection surfaces are mated and the coating formation portions 55 are held between the two recoating grooves 58 and 59.

At the two outer sides of the recoating grooves 58 and 59 of the upper mold 56 and lower mold 57 in the longitudinal direction, engagement grooves 63 and 64 able to receive parts of the coated portions connected to the coating formation portions 55 of the optical fibers 21A and 21B set between the recoating grooves 58 and 59 are formed.

The lower surface 61 of the upper mold 56 and the upper surface of the lower mold 57 are formed with supply grooves 65 and 66 in a direction intersecting the recoating grooves 58 and 59. When the recoating grooves 58 and 59 are mated with each other (the upper mold 56 is placed over the lower mold 57), the supply grooves 65 and 66 are also mated and a channel formed for injecting the ultraviolet curing resin 90 is formed between the recoating grooves 58 and 59 where the coating formation portions 55 of the optical fibers 21A and 21B is set.

The ultraviolet light source 67 is attached to an inside surface 4a of the upper lid 4. In this embodiment, the ultraviolet light source 67 used is an ultraviolet laser diode (UVLD) or ultraviolet light emitting diode (UVLED). One or more ultraviolet laser diodes or ultraviolet light emitting diodes may be used for the ultraviolet light source. When using a plurality of ultraviolet laser diodes or ultraviolet light emitting diodes, they may be arranged in a one-dimensional, two-dimensional, or three-dimensional array. In the illustration of FIG. 28, the ultraviolet laser diodes are arranged two dimensionally to the front and back and to the left and right.

As the ultraviolet laser diode, it is possible to use a generally used laser diode emitting ultraviolet light.

The ultraviolet light emitting diode is a light emitting diode emitting ultraviolet light. For example, it is possible to use a Model NSHX 180F ultraviolet light emitting diode made by Nichia Chemical Industry. The Model NSHX 180F ultraviolet light emitting diode has a surface mounting type package of 10 mm length, 10 mm width, and 2.3 mm height. The panel shaped light emitting diode is arranged as explained above and used.

The mold assembly 50 can be changed. By changing the mold assembly 50, it is possible to use various shapes of mold assemblies.

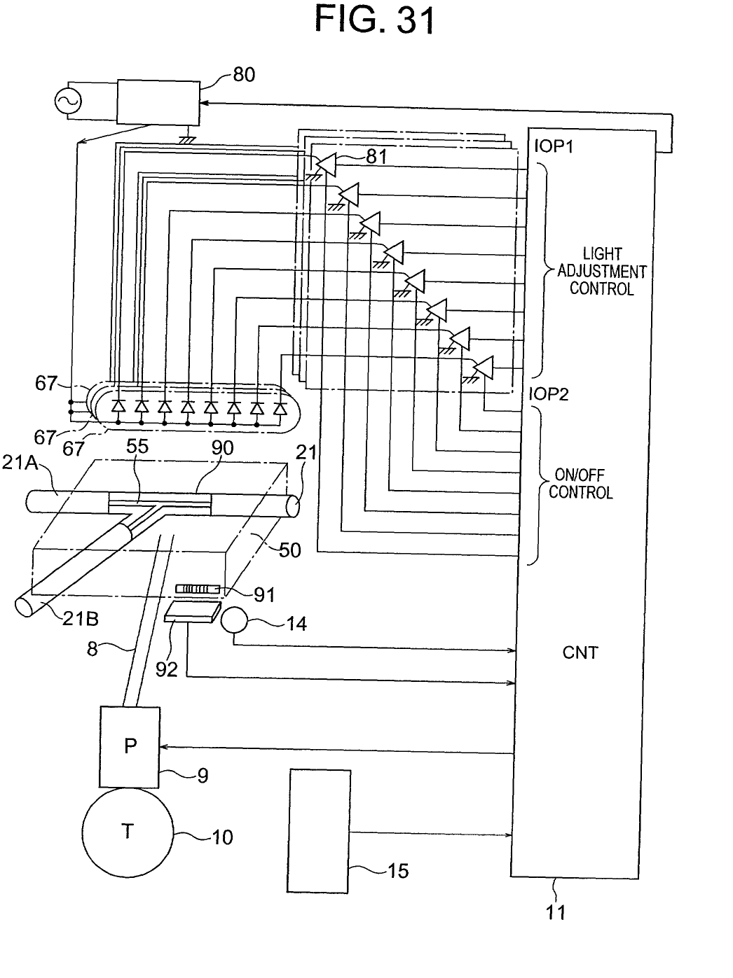

As illustrated in FIG. 31, the mold assembly 50 is coded by type. The code showing this (code label) 91 is displayed on the mold assembly 50. The control circuit 11 is provided with a plurality of programs for controlling functions and operations in accordance with the type of the mold assembly 50. The code 91 displayed at the mold assembly 50 may be read, a suitable program selected in accordance with the mold assembly 60, and the ultraviolet laser diodes or ultraviolet light emitting diodes to be used selected in accordance with the shape of the mold assembly 50 so as to adjust the light.

When closing the upper lid 4 and lighting the ultraviolet light source 67, light emitted from the ultraviolet light source 67 is irradiated at the mold assembly 50 and the ultraviolet curing resin filled between the recoating grooves 58 and 59 of the mold assembly 50 is cured. Further, the ceiling of the upper lid 4 is provided with a rectangular check window 68 enabling confirmation of the inside state of injection or cured state of the ultraviolet curing resin even without opening the upper lid 4. The check window 68 is provided with a sliding lid 69 enabling opening and closing of the window. When the lid 69 is slid to open the check window 68, the injection state or cured state of the ultraviolet curing resin can be confirmed. When it is slid to close the check window 68, the entry of outside light can be prevented.

When a predetermined switch (button) of the control panel 15 is depressed to operate the pump 9 through the control circuit 11, the ultraviolet curing resin held in the tank 10 is pumped to the pipe 8. The ultraviolet curing resin sent to the pipe 8 is filled in the space of the recoating grooves 58 and 59 where the coating formation portions 55 are set through the supply grooves 65 and 66.

To coat the coating formation portions 55 of the optical fibers, the operator performs the following operation:

Step 1: The operator opens the upper lid 4, then swings open the upper lid 56 in the same direction.

Step 2: The operator sets the coating formation portions 55 of the optical fibers 21A and 21B from above in the recoating groove 59 formed in the upper surface 62 of the lower mold 57 and sets the outside coated portions connected to the coating formation portions 55 of the optical fibers 21A and 21B in the engagement groove 64 of the lower mold 57.

Step 3: The operator swings down the upper mold 56 to place it on top of the lower mold 57 so that the recoating grooves 58 and 59 and engagement grooves 63 and 64 of the upper mold 56 and lower mold 57 mate and so that the coating formation portions 55 are held between the mated recoating grooves 58 and 59 and the outside coated portions connected to the coating formation portions 55 are held between the mated engagement grooves 63 and 64.

Step 4: The operator clamps the coated portions of the optical fibers sticking out from the mold assembly 50 by the clamps 75A and 75B projecting out from the two sides of the lower housing 3 in the longitudinal direction.

Step 5: The operator closes the upper lid 4 to cover the mold assembly 50. The two sides of the upper lid 4 in the longitudinal direction are provided with changeable side plates 78 formed with narrow notches 76 so that the optical fibers 21A and 21B are not pinched by the upper lid 4 when the upper lid 4 is closed. Further, the side plates 78 are changed in accordance with a change of the mold assembly 50.

Step 6: The operator pushes a predetermined switch (button) on the control panel 15 to operate the pump 9 through the control circuit 11 and inject the ultraviolet curing resin (for example, an ultraviolet curing epoxy-based acrylate resin) 90 in a tank 71 between the previously mated recoating grooves 58 and 59 to fill the area around the coating formation portions 55. At this time, in accordance with need, the operator operates the lid 69 of the upper lid 4 to open the check window 68 and confirm the state of injection of the UV curing resin.

Step 7: The operator pushes a switch (button) of the control panel 15 to light the ultraviolet light source 67 through the control circuit 11 and irradiate the ultraviolet curing resin filled around the coating formation portions 55 of the optical fibers 21A and 21B with ultraviolet light and cure the resin. At this time, in accordance with need, the operator operates the lid 69 of the upper lid 4 to open the check window 68 and confirm the cured state of the UV curing resin 90. The optical fiber resin coating apparatus is provided with a light receiving sensor (for example, an ultraviolet sensor) 14 able to detect the amount of ultraviolet light irradiated at the mold assembly 50. The control circuit 11 compares the results of detection of the ultraviolet sensor 14 with a preset table value, calculates the difference, and automatically adjusts the amount of light of the ultraviolet light source 67 so that the difference becomes extremely small.

Step 8: After the ultraviolet curing resin is sufficiently cured, the operator opens the upper lid 4, then swings open the upper mold 56 in the same direction and takes out the coated and cured optical fiber 21.

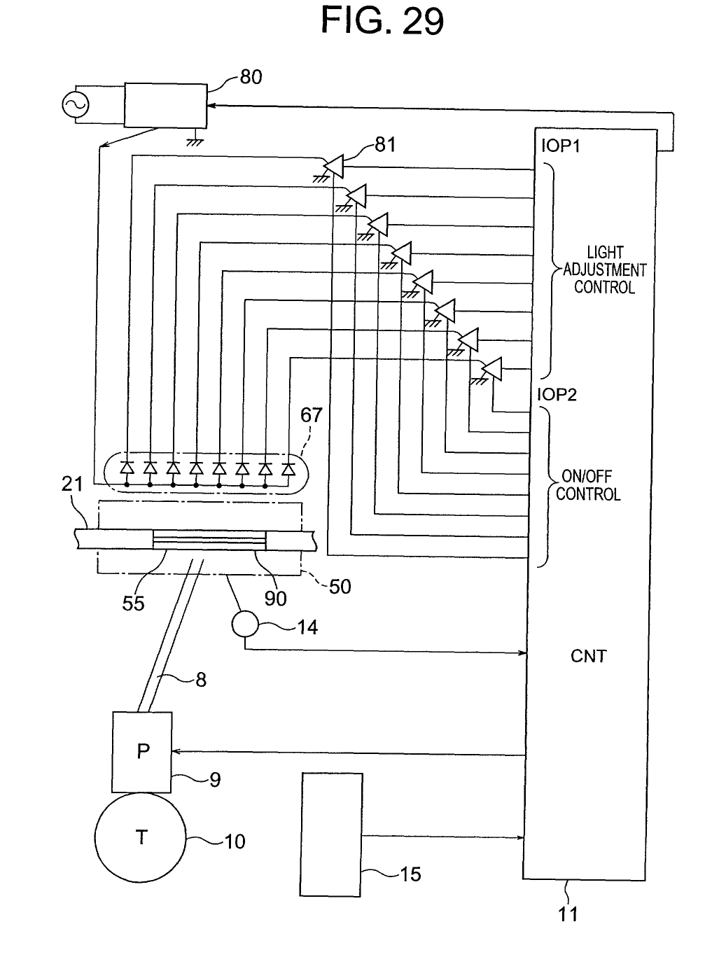

FIG. 29 is a view of the control system.

The injection of the ultraviolet curing resin into the mold assembly 50 is instructed to the control circuit 11 by the operator depressing a switch (button) of the control panel 15. Receiving the instruction, the control circuit 11 operates the pump 9 to send a suitably amount of the ultraviolet curing resin from the tank 10 to the pipe 8. The control circuit 11 supplies power from the low voltage power source 80 to the ultraviolet laser diodes (or ultraviolet light emitting diodes) 67 in accordance with values of a previously input data table so as to light the ultraviolet laser diodes (or ultraviolet light emitting diodes) 67 and irradiate the area around the coating formation portions 55 with ultraviolet light from the ultraviolet laser diodes (or ultraviolet light emitting diodes). The control circuit 11 compares the intensity of light received by the ultraviolet sensor 14 with the table value and instructs the adjustment of the amount of light to driver IC's 81 based on the results of the comparison.

It is also possible to light up individual ultraviolet laser diodes (or ultraviolet light emitting diodes) 67 of the plurality of diodes arranged in a horizontal row (one-dimensional array) by operation of the control circuit 11. In this case, switches of the control panel 15 are operated to issue instructions to the plurality of driver IC's 81 individually connected to the ultraviolet laser diodes (or ultraviolet light emitting diodes) 67 to select the ultraviolet laser diodes (or ultraviolet light emitting diodes) to emit light and thereby obtain the desired profile of intensity of light (luminance).

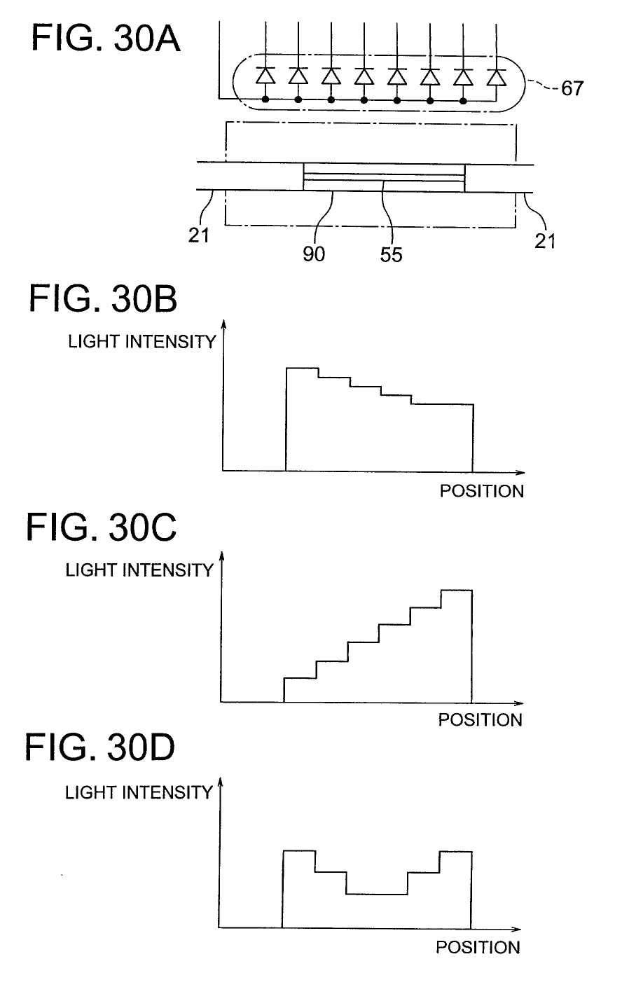

FIG. 30B shows the profile of intensity of light when not lighting the ultraviolet laser diode (or ultraviolet light emitting diode) at the right side in the plurality of ultraviolet laser diodes (ultraviolet light emitting diodes), FIG. 30C shows the profile of the intensity of light when not lighting the ultraviolet laser diode (or ultraviolet light emitting diode) at the left side, and FIG. 30D shows the profile of the intensity of light when not lighting an ultraviolet laser diode (or ultraviolet light emitting diode) at the middle. In this case, by changing the current flowing through the individual ultraviolet laser diodes (or ultraviolet light emitting diodes) by the control circuit 11, rather than turn off individual ultraviolet laser diodes (or ultraviolet light emitting diodes), it is also possible to reduce the intensity of the light emitted.

The control circuit 11 is comprised of an electronic circuit using a microcomputer. It has a built-in program and oversees the control of the optical fiber resin coating apparatus such as control of the pump 9 and transfer of commands from the control panel 15 in addition to the above adjustment of the light. As illustrated in FIG. 29, the control circuit 11 is provided with an ON-OFF controller for controlling the driver IC's 81 to turn ON or OFF and a light adjustment controller.

Modification of Third Embodiment

A modification of the third embodiment of the present invention will be explained next with reference to FIG. 31.

The ultraviolet light source 67 of FIG. 31 uses a plurality of ultraviolet laser diodes or ultraviolet light emitting diodes. It arranges a plurality of these in a horizontal line and arranges a plurality of these lines front to back to form a two-dimensional array. Each ultraviolet laser diode or ultraviolet light emitting diode of each row is connected to an individual driver IC 81. By selecting the ultraviolet laser diodes or ultraviolet light emitting diodes to emit light or reduce the intensity of light, it is possible to give any profile of luminance.

The rest of the components are the same as those illustrated in FIG. 28 to FIG. 30.

The mold assembly 50 is coded by type. A code showing this (code label) 91 is displayed (attached) at the mold assembly 50. The control circuit 11 is provided with a plurality of programs for controlling functions and operations in accordance with the type of the mold assembly 50. The code of the code label 91 attached to the mold assembly 50 may be read by a code reader 92 to judge and identify the type of the mold assembly 50, a suitable program selected, and the ultraviolet laser diodes or ultraviolet light emitting diodes to be used selected in accordance with for example the shape of the mold assembly 50 so as to adjust the light.

Fourth Embodiment

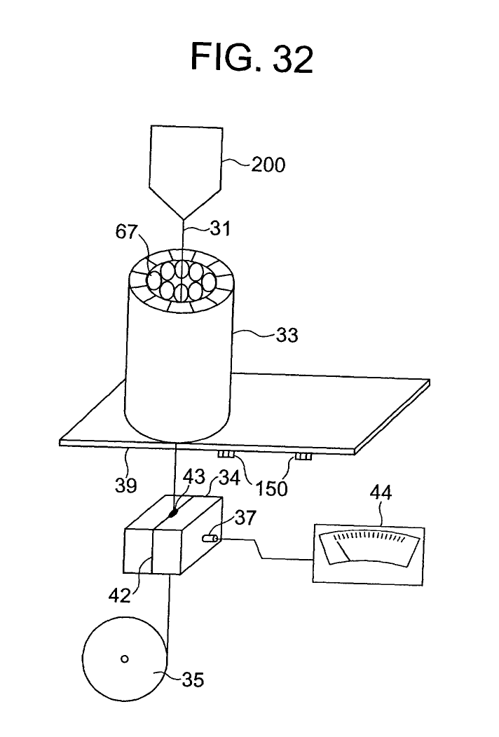

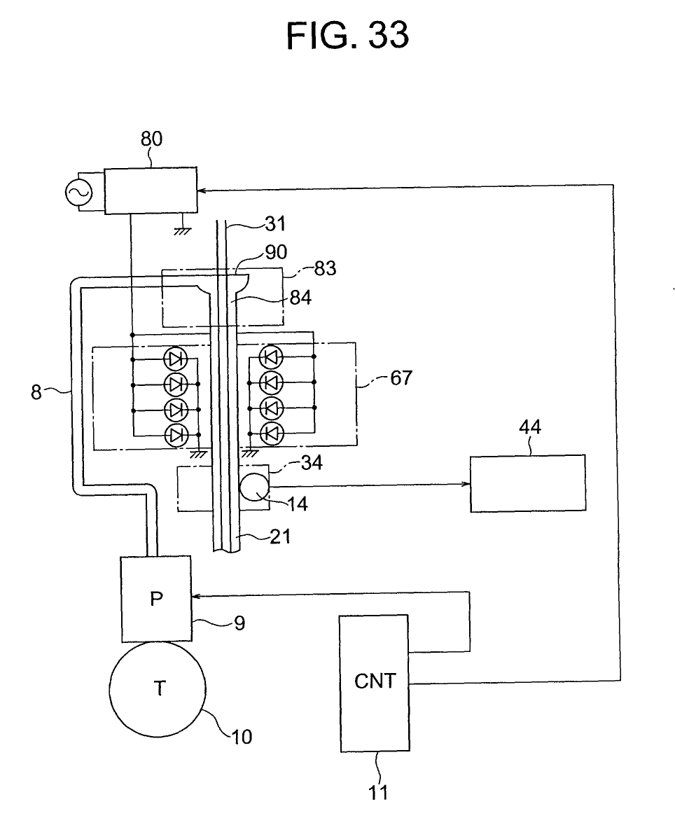

An optical fiber resin coating apparatus and method according to a fourth embodiment of the present invention will be explained next with reference to FIG. 32 and FIG. 33.

The fourth embodiment of the present invention is an optical fiber resin coating apparatus used for coating an ultraviolet curing resin on the periphery of a naked optical fiber 31 drawn from a preform 200 in a drawing furnace.

The ultraviolet curing resin is deposited on the periphery of the drawn naked optical fiber 31 by pumping ultraviolet curing resin in a tank 10 by a pump 9, sending it through a pipe 8 to a cup 83, and sending it from the cup 83 to a passage 84. Due to this, the ultraviolet curing resin 90 is automatically deposited on the periphery of the naked optical fiber 31 which is drawn and is passing through the passage 84. The ultraviolet curing resin 90 is cured by being irradiated by the ultraviolet light output from a plurality of ultraviolet laser diodes or ultraviolet light emitting diodes 67.

In the optical fiber resin coating apparatus of this embodiment, a plurality of ultraviolet laser diodes or ultraviolet light emitting diodes are used for the ultraviolet light source 67 in the same way as in the third embodiment. A plurality of these are arranged in a horizontal row at the ultraviolet resin coating portion 33 on a plate 39. A plurality of these rows are arranged from front to back. Further, these rows are arranged three-dimensionally in the vertical direction as well. The three-dimensionally arranged ultraviolet laser diodes or ultraviolet light emitting diodes are selected, lit, and adjusted by operation of the switches of the control panel to enable the profile of the intensity of light to be adjusted through the control circuit 11. Further, it is possible to control the direction of irradiation of light by selecting the ultraviolet laser diodes or ultraviolet light emitting diodes which are lit.

The optical fiber resin coating apparatus of this embodiment is provided with a light shield 34 and a meter 44.

The coated optical fiber 21 coated with the ultraviolet curing resin and emerging from the ultraviolet resin coater 33 passes through the light shield 34 and is taken up on a takeup reel 35. The light shield 34 is provided with an ultraviolet sensor 14 detecting the ultraviolet light. The ultraviolet sensor 14 detects the ultraviolet light disassociated from the coating of the coated optical fiber 21 passing through the light shield 34 to detect the coated fiber 21.

The optical shield 34 is comprised of two members 22 joined through connection parts 42. The connection parts 42 of the two members 22 are provided with longitudinally oriented recesses. A hole 43 is formed by these facing recesses. The coated optical fiber 21 can pass through the hole 43. The ultraviolet sensor 14 is electrically connected to the meter 44. Using the meter 44, it is possible to read the intensity of the ultraviolet light converted to an electrical signal by the ultraviolet sensor 14. Of course, it is also possible to input the measured value of the ultraviolet sensor 14 into the control circuit 11. The intensity of this ultraviolet light is proportional to the intensity of the ultraviolet light entering the coated optical fiber 21. Using this reading, the control circuit 11 can select the ultraviolet laser diodes or ultraviolet light emitting diodes for adjusting the emission state in the ultraviolet laser diodes or ultraviolet light emitting diodes 67 arranged in a three-dimensional array and obtaining ultraviolet light of the desired profile of intensity for the ultraviolet curing resin deposited on the periphery of the naked optical fiber 31.

In the optical fiber resin coating apparatus of this embodiment as well, it is possible to adjust the posture of the ultraviolet resin coater 33 by bolts 150 provided at the plate 39. Due to this, it is possible to suitably align the ultraviolet laser diodes or ultraviolet light emitting diodes 67 with the naked optical fiber 31. By selecting the ultraviolet laser diodes or ultraviolet light emitting diodes in the above way, it becomes possible to eliminate the trouble of adjustment.

In the conventional optical fiber resin coating apparatus, a long, low ultraviolet emission efficiency tungsten lamp, a mercury discharge arc lamp, a microwave electroless lamp, or other ultraviolet lamp was used. Therefore, the power source for supplying power to the lamp and in turn the optical fiber resin coating apparatus became larger in size and it was difficult to adjust the ultraviolet light to match with the naked optical fiber 31.

The optical fiber resin coating apparatus of the present embodiment uses one or more ultraviolet laser diodes or ultraviolet light emitting diodes for the ultraviolet light source, and therefore has the following advantageous effects:

1. The efficiency of conversion of power to ultraviolet light is good, so it is possible to reduce the voltage of the power source compared with when the light source is a discharge lamp. As an example of the light source, a discharge lamp consumes 100 to 300V, while an ultraviolet laser diode or ultraviolet light emitting diode consumes 5 to 12V. Therefore, the power source becomes smaller in size and lighter in weight.

2. The optical fiber resin coating apparatus becomes lower in power consumption and gives an output power one-third that of the conventional high voltage power source. Therefore, the optical fiber resin coating apparatus becomes smaller in size and lighter in weight.

3. Adjustment becomes easier since the gas or glass which had been used for the lamp becomes unnecessary.

4. The light source ultraviolet laser diodes or ultraviolet light emitting diodes are small, and hence can be used in any array. It is possible to arrange them to emit ultraviolet light in accordance with the object in question and to finely adjust the light in accordance with the object.

The optical fiber resin coating apparatus of this embodiment irradiates the ultraviolet curing resin deposited at the periphery of a naked optical fiber drawn from a preform with ultraviolet light from ultraviolet laser diodes or ultraviolet light emitting diodes, and therefore is suitable for curing an ultraviolet curing resin while drawing an optical fiber from a preform.

The optical fiber resin coating apparatus of this embodiment irradiates the ultraviolet curing resin filled at the periphery of the coating formation portion of the optical fiber set in the groove of the mold assembly in the housing with ultraviolet light from the ultraviolet laser diodes or ultraviolet light emitting diodes, and is thus suitable for coating the coating formation portion for reinforcement after stripping off the coating for processing.

The optical fiber resin coating apparatus of this embodiment is provided with a control circuit for controlling the functions and operations such as the emission of the ultraviolet light and injection of the ultraviolet curing resin, so it is possible to control various functions such as the control of the intensity of the ultraviolet light and the amount of injection and timing of the ultraviolet curing resin to cure the ultraviolet curing resin in the optimal state.

The optical fiber resin coating apparatus of this embodiment comprises a plurality of ultraviolet laser diodes or ultraviolet light emitting diodes in a one-dimensional array, two-dimensional array, or three-dimensional array, so the diodes can be arrayed in accordance with the object to be irradiated with the ultraviolet light or the intensity of the light can be finely adjusted.

The optical fiber resin coating apparatus of this embodiment can select, control, and use any of the plurality of ultraviolet laser diodes or ultraviolet light emitting diodes, and therefore can cure the ultraviolet curing resin in the optimal state by that selection and control.

The optical fiber resin coating apparatus of this embodiment is designed to enable the mold assembly to be changed. Therefore, it is possible to change the shape, length, etc. of the mold assembly and possible to cure the ultraviolet curing resin at the coating formation portion in the optimal state.

The optical fiber resin coating apparatus of this embodiment assigns a code for the type of the mold assembly and attaches the code showing that type to the mold assembly, so it is possible to select the mold assembly based on the code and more easily change and manage mold assemblies.

The optical fiber resin coating apparatus of this embodiment is provided with programs enabling the control circuit to control the functions for each type of mold assembly and operates by reading the code attached to the mold assembly and selecting the suitable program. Therefore, by just changing the mold assembly, it is possible to inject the ultraviolet curing resin and automatically control the irradiation of ultraviolet light etc. in a manner matching the mold assembly to cure the ultraviolet curing resin in the optimal state.

Note that the present invention is not limited to the examples shown in the above embodiments. Various modifications are possible. In these embodiments, the explanation was given taking as an example an optical fiber, but the invention may also be applied to coating a coating formation portion of an optical component.

In the present invention, the above embodiments include various intermediate aspects of the invention. Various aspects of the invention can be derived by suitably combining the requirements disclosed. For example, even if omitting several requirements from the overall requirements shown in the embodiments, it is possible to achieve one or more of the objects defined in the summary of the invention. When obtaining at least one of the effects of the present invention, the invention stands even if some of the requirements of the embodiments are omitted.

According to the present invention, it is possible to provide an optical fiber resin coating apparatus featuring a short processing time of the optical fiber and small dimensions.

According to the present invention, it is also possible to provide an optical fiber resin coating apparatus using a power source of a small power consumption and small sized structure.

Further, according to the present invention, it is possible to provide an optical fiber resin coating apparatus featuring a short processing time of the optical fiber and able to irradiate ultraviolet light of a suitable intensity.

According to the present invention, it is also possible to provide an optical fiber resin coating apparatus creating an array of ultraviolet light in accordance with the object irradiated and finely adjusting the light in accordance with the object.

Further, according to the present invention, it is also possible to provide an ultraviolet curing resin coating apparatus and an optical fiber resin coating apparatus able to coat an ultraviolet curing resin from which foam and gas have been removed.

According to the present invention, it is possible to provide an ultraviolet curing resin coating method and optical fiber resin coating method able to coat an ultraviolet curing resin from which foam and gas have been removed by gradually curing the coating formation portion from the ends when coating a coating formation portion of an optical fiber using an ultraviolet curing resin.

While the invention has been described with reference to specific embodiments chosen for purpose of illustration, it should be apparent that numerous modifications could be made thereto by those skilled in the art without departing from the basic concept and scope of the invention.

What is claimed is:

1. An optical fiber resin coating apparatus comprising:
an ultraviolet flash lamp for emitting ultraviolet light for curing an ultraviolet curing resin coated on an optical fiber,
a lamp lighting means for lighting said ultraviolet flash lamp, and
a control means for controlling said lamp lighting circuit to light said ultraviolet flash lamp for a short time.

2. An optical fiber resin coating apparatus as set forth in claim 1, wherein
said lamp lighting means comprises:
a switching means for turning ON or OFF power supplied to said ultraviolet flash lamp and
a power storing means for storing power to be supplied to said ultraviolet flash lamp when said switching means is in an OFF state and for supplying stored power to said ultraviolet flash lamp through said switching means when said switching means is in an ON state, and
said control means controls said switching means to turn ON or OFF.

3. An optical fiber resin coating apparatus as set forth in claim 2, further comprising
a plurality of circuits each comprised of a switching means for turning ON or OFF power supplied to said ultraviolet flash lamp and a power storing means for storing power to be supplied to said ultraviolet flash lamp when said switching means is in an off state and for supplying stored power to said ultraviolet flash lamp through said switching means when said switching means is in an on state,
said control means controlling switching means of said plurality of circuits to turn ON or OFF by a predetermined period.

4. An optical fiber resin coating apparatus comprising:
an ultraviolet flash lamp for emitting ultraviolet light for curing an ultraviolet curing resin coated on an optical fiber,
a lamp lighting means for lighting said ultraviolet flash lamp,
an ultraviolet light measuring means for measuring an intensity and emission time of ultraviolet light emitted from said ultraviolet flash lamp, and
an ultraviolet flash lamp excitation control means for calculating a voltage for exciting said ultraviolet flash lamp and excitation time by referring to the intensity and emission time of ultraviolet light measured by said ultraviolet light measuring means and supplying the same to said power source means,
said lamp lighting means lights said ultraviolet flash lamp in response to the excitation voltage and excitation time supplied from said control means.

5. An optical fiber resin coating apparatus as set forth in claim 4, wherein
said ultraviolet curing resin is cured by emission of said ultraviolet flash lamp by a preparatory emission step and a main processing step, and
said control means calculates a voltage for exciting said ultraviolet flash lamp and excitation time in said main processing step based on the intensity and emission time of ultraviolet light measured by said measuring means in said preparatory emission step.

6. An optical fiber resin coating method comprising the steps of:
coating an ultraviolet curing resin as an outer coating of an optical fiber,
curing said coated ultraviolet curing resin by supplying voltage to an ultraviolet flash lamp to cause said ultraviolet flash lamp to emit ultraviolet light,
measuring an intensity and emission time of said ultraviolet light, and
calculating a voltage for exciting said ultraviolet flash lamp and excitation time by referring to the measured intensity and emission time of ultraviolet light and supplying the voltage to said ultraviolet flash lamp,
in said voltage supplying step, said ultraviolet flash lamp being lit in response to the excitation voltage supplied at said control step and excitation time.

7. An optical fiber resin coating method as set forth in claim 6, further comprising a preparatory emission step and main processing step for curing said ultraviolet curing resin by emission of said ultraviolet flash lamp, in said control step a voltage for exciting said ultraviolet flash lamp and excitation time at said main processing step is calculated based on the intensity and emission time of the ultraviolet light measured at said measuring step in said preparatory emission step.

8. An optical fiber resin coating apparatus which coats a periphery of an optical fiber with an ultraviolet curing resin and irradiates the ultraviolet curing resin with ultraviolet light to cure the ultraviolet curing resin, wherein at least one ultraviolet laser diode or ultraviolet light emitting diode is used for a light source of the ultraviolet light.

9. An optical fiber resin coating apparatus which coats a periphery of an optical fiber with an ultraviolet curing resin and irradiates the ultraviolet curing resin with ultraviolet light to cure the ultraviolet curing resin, said optical fiber drawn from a preform, at least one ultraviolet laser diode or ultraviolet light emitting diode used for an ultraviolet light source.

10. An optical fiber resin coating apparatus which fills an ultraviolet curing resin at a periphery of a coating formation portion of an optical fiber set in a groove of a mold assembly in a housing, irradiates the ultraviolet curing resin with ultraviolet light to cure the ultraviolet curing resin, and thereby coats the coating formation portion of the optical fiber, wherein
at least one ultraviolet laser diode or ultraviolet light emitting diode is used for an ultraviolet light source.

11. An optical fiber resin coating apparatus as set forth in claim 10, comprising a control means for controlling operation of said ultraviolet light source, injection of ultraviolet curing resin, and other functions and operations.

12. An optical fiber resin coating apparatus as set forth in claim 10, wherein said plurality of ultraviolet laser diodes or ultraviolet light emitting diodes are arranged in one of a one-dimensional array, two-dimensional array, and three-dimensional array.

13. An optical fiber resin coating apparatus as set forth in claim 10, wherein said mold assembly can be changed.

14. An optical fiber resin coating apparatus as set forth in claim 13, wherein
a type of said mold assembly is encoded, and
said control means reads and recognizes a code attached to said mold assembly and performs corresponding processing.

15. An optical fiber resin coating apparatus provided with an ultraviolet light source for irradiating an uncured ultraviolet curing resin covering a coating formation portion of an optical fiber by ultraviolet light of an inclined profile where the intensity of the ultraviolet light gradually changes depending on the position.

16. An optical fiber resin coating apparatus as set forth in claim 15, comprising a light shielding means for partially blocking said ultraviolet light source and partially blocking said source by said light shielding means so as to form a penumbra in the ultraviolet light irradiated on the ultraviolet curing resin from the ultraviolet light source to obtain said inclined profile.

17. An optical fiber resin coating apparatus as set forth in claim 16, further comprising:
a pair of said ultraviolet light sources straddling an ultraviolet irradiated region of the ultraviolet curing resin, each ultraviolet light source provided with a light shielding means for partially blocking the ultraviolet light source, and
a control means for controlling the pair of ultraviolet light sources to turn on intermittently at different timings; and
partially blocking the ultraviolet light source by said light shielding means to form penumbras in the ultraviolet light irradiated on the ultraviolet curing region from the ultraviolet light sources and controlling the pair of ultraviolet light sources to intermittently turn ON to obtain said inclined profile.

18. An optical fiber resin coating apparatus as set forth in claim 16, wherein said ultraviolet light source outputs a spot of light, said apparatus further comprises a drive movement means for driving the movement of the position of the ultraviolet light source and a control means for controlling the drive movement means to gradually change the speed of movement of the ultraviolet light source, and forms the ultraviolet light irradiated on the ultraviolet curing resin from the ultraviolet light source to give said inclined profile in accordance with the change in movement speed of said spot of light.

19. An apparatus for coating an optical fiber as set forth in claim 16, wherein
said ultraviolet light source comprises a drive means arranged at a position offset from an area of the ultraviolet curing resin irradiated by the ultraviolet light and forming the output light to a spot of light or rotating said ultraviolet light source to scan the direction of irradiation of ultraviolet light across the area of the ultraviolet curing resin irradiated by the ultraviolet light at a constant speed, and
uses the change in distance of irradiation due to movement of the spot of light to make the ultraviolet light irradiated on the ultraviolet curing resin from the ultraviolet light source exhibit said inclined profile.

20. An optical fiber resin coating apparatus as set forth in claim 16, further comprising:
an optical filter where the amount of ultraviolet light passed successively changes according to the position, and
the ultraviolet light from said ultraviolet light source irradiating an area of the ultraviolet curing resin irradiated by the ultraviolet light so that the ultraviolet light irradiated on the ultraviolet curing resin in the area of the ultraviolet curing resin exhibits said inclined profile.

21. An optical fiber resin coating method comprising the steps of covering and coating a coating formation portion of an optical fiber by an ultraviolet curing resin by irradiating an uncured ultraviolet curing resin covering said coating formation portion of said optical fiber with ultraviolet light exhibiting an inclined profile where the intensity of the ultraviolet light gradually changes depending on the position and performing the curing processing to successively move from one uncured position to another.
